(19) United States
(12) Patent Application Publication
(10) Pub. No.: US 2014/0147744 A1
(43) Pub. Date: May 29, 2014

(54) POSTIVE ELECTRODE MATERIAL FOR LITHIUM ION SECONDARY BATTERY, POSITIVE ELECTRODE FOR LITHIUM ION SECONDARY BATTERY, AND LITHIUM ION SECONDARY BATTERY

(71) Applicants: Atsushi Nemoto, Hamura-shi (JP); Maki Moriya, Ota-ku (JP); Hirokazu Sasaki, Shinagawa-ku (JP)

(72) Inventors: Atsushi Nemoto, Hamura-shi (JP); Maki Moriya, Ota-ku (JP); Hirokazu Sasaki, Shinagawa-ku (JP)

(73) Assignee: SHOEI CHEMICAL INC., Tokyo (JP)

(21) Appl. No.: 14/130,116

(22) PCT Filed: Jul. 2, 2012
(86) PCT No.: PCT/JP2012/066842

§ 371 Date: Dec. 30, 2013

(30) Foreign Application Priority Data
Jul. 4, 2011 (JP) 2011-147895

(51) Int. Cl. H01M 4/36

(52) U.S. Cl. CPC H01M 4/364
USPC 429/211; 252/506

(57) ABSTRACT

Provided is a cathode material for lithium ion secondary battery containing a composite material of a lithium silicate crystal and a carbon material. The composite material shows a peak in a wave number range from 1400 cm⁻¹ to 1550 cm⁻¹ in infrared absorption spectrum and shows no peak in a wave number range from 1000 cm⁻¹ to 1150 cm⁻¹ in Raman spectrum.

### TECHNICAL FIELD

The present invention relates to a cathode material for lithium ion secondary battery, a cathode for lithium ion secondary battery and a lithium ion secondary battery.

### BACKGROUND ART

Lithium ion secondary battery has lighter weight and larger capacity as compared with conventional lead secondary battery, nickel-cadmium secondary battery and so forth, and has widely been used as a power source for electronic devices such as mobile phone, notebook type personal computer and so forth. It has recently been used also as batteries for electric vehicle, plug-in hybrid car, pedelec and so forth.

The lithium ion secondary battery is basically composed of a cathode, an anode, an electrolyte (electrolytic solution) and a separator. For example, carbon, lithium titanate and so forth, which allow intercalation and deintercalation of metallic lithium or lithium ion, are used as the anode, meanwhile lithium salt, and organic solvent or ionic liquid capable of dissolving therein the lithium salt, are used as the electrolyte. The separator is placed between the cathode and the anode so as to keep electrical isolation between the cathode and the anode, while allowing the electrolyte to pass through the pores thereof and is configured by using, for example, porous organic resin, glass fiber or the like.

The cathode is basically configured by an active material which allows intercalation and deintercalation of lithium ion, an electrically conductive auxiliary which ensures electric conduction path (electron conduction path) to a current collector, and a binder which binds the active material and the electrically conductive auxiliary. The electrically conductive auxiliary is typically configured by using a carbon material such as acetylene black, carbon black, graphite or the like.

Known cathode active materials for lithium ion secondary battery include oxide-based materials which have already been put into practical use (for example, LiCoO₂, LiNiO₂, LiMn₂O₄, etc.), olivine-based materials which have partially been put into practical use (for example, LiFePO₄, LiMnPO₄, LiNiPO₄, etc.), and lithium silicate-based materials which are still in the study phase (for example, Li₂FeSiO₄, Li₂MnSiO₄, etc.).

In particular, the lithium silicate-based materials are under active research and development since they allow a bielectron reaction to proceed, larger in the theoretical capacity as compared with other cathode active materials and are therefore expected for larger capacity and larger energy density (see Patent Literatures 1 to 5 and Non-Patent Literatures 1 and 2, for example).

For example, Patent Literatures 1 to 3 propose compositions of the electrode active material for the lithium ion secondary battery. Patent Literature 4 proposes a method of manufacturing a lithium silicate-based material using a polymer compound as a silica source for aiming at increasing the capacity. Patent Literature 5 proposes improvement in the electric conductivity of inorganic grains used as the active material to thereby increase the capacity.

The lithium silicate is generally low in electron conductivity. Efforts have therefore been made on improving the electron conductivity of the cathode which uses the lithium silicate-based material as the active material, typically by mixing the lithium silicate with an electrically conductive auxiliary or by providing a carbon coating or by allowing carbon grains, carbon fibers or the like to adhere on the surface of lithium silicate (see Patent Literatures 6 to 11, for example). In particular, the carbon coating on the surface of lithium silicate has been considered to be effective for the purpose of obtaining excellent battery characteristics.

### CITATION LIST

### Patent Literature

Patent Literature 1: JP2001-266682A
Patent Literature 2: Published Japanese Translation of PCT
International Publication No, 2005-519451
Patent Literature 3: JP2007-335325A
Patent Literature 4: WO2008/123311, Pamphlet
Patent Literature 5: JP2009-302044A
Patent Literature 6: JP2003-34534A
Patent Literature 7: JP2006-302671A
Patent Literature 8: JP2002-75364A
Patent Literature 9: JP2003-272632A
Patent Literature 10: JP2004-234977A
Patent Literature 11: JP2003-59491A

### Non-Patent Literature

Non-Patent Literature 1: Akira KOJIMA, Toshikatsu KOJIMA, Takubiro MIYUKI, Yasue OKUYAMA, Tetsuo SAKAI, Proceedings of 51st Symposium of Batteries, (2010) 194,
Non-Patent Literature 2: Yuichi KAMIMUKA, Eiji KOBAYASHI, Takayuki DOI, Shigeto OKADA, Jun-ichi YAMAKI, Proceedings of 50th Symposium of Batteries, (2009) 30,

### SUMMARY OF THE INVENTION

### Technical Problem

The lithium silicate-based material such as Li₂FeSiO₄ and Li₂MnSiO₄ are capable of allowing the bielectron reaction to proceed, from which a theoretical capacity as high as 330 mAh/g is expectable. Not many reports have, however, described achievement of an actual capacity of 1 Li (165 mAh/g) or larger, and no report has described an actual capacity of 1.5 Li or larger. For example, the actual capacity described in Patent Literature 3 is 60 to 130 mAh/g and the values described in Non-Patent Literatures 1 and 2 are 190 mAh/g and 225 mAh/g at most, respectively.

As described above, the lithium silicate-based material and derivatives thereof, despite expectation of large theoretical capacity, have failed to achieve an expected level of high capacity even when actually manufactured and measured.

The present invention was conceived in consideration of this situation and an object is to provide a cathode material for lithium ion secondary battery, a cathode, and a lithium ion secondary battery capable of obtaining large capacity and large energy density.

### Means to Solve the Problem

The present inventors have found out from our diligent investigations into the lithium silicate-based material, that large capacity and large energy density of the lithium ion secondary battery were successfully achieved by using, as the cathode material, a composite material of lithium silicate-based material and a carbon material, obtained by a specific manufacturing method described later. From our further investigation into the cathode material which contains the composite material obtained by our manufacturing method, the present inventors found that our cathode material has a structural feature which has not been found in the conventional lithium silicate-based materials, and that the large capacity and large energy density were considered to be attributable to the structure. The present invention was thus completed.

More specifically, the cathode material of the present invention contains a composite material of a lithium silicate crystal and a carbon material. The composite material shows, in infrared absorption spectrum, peak(s) in the wave number range from 1400 cm⁻¹ to 1550 cm⁻¹, and shows, in Raman spectrum, no peak in the wave number range from 1000 m⁻¹ to 1150 cm⁻¹.

### Advantageous Effects of Invention

According to the present invention, it is now possible to obtain a cathode material for lithium ion secondary battery, a cathode, and a lithium ion secondary battery having large capacity and large energy density.

### BRIEF DESCRIPTION OF DRAWINGS

FIG. 1 is an exemplary infrared absorption spectral chart according to the present invention;

FIG. 2 is an exemplary Raman spectral chart according to the present invention;

FIG. 3 is an exemplary XPS spectral chart according to the present invention;

FIG. 4 is a charge/discharge diagram of Example 1 and Comparative Example 1;

FIG. 5A is an infrared absorption spectral chart of Example 1;

FIG. 5B is a Raman spectral chart of Example 1;

FIG. 6A is an infrared absorption spectral chart of Example 2;

FIG. 6B is a Raman spectral chart of Example 2;

FIG. 7A is an infrared absorption spectral chart of Example 3;

FIG. 7B is a Raman spectral chart of Example 3;

FIG. 8A is an infrared absorption spectral chart of Example 4;

FIG. 8B is a Raman spectral chart of Example 4;

FIG. 9A is an infrared absorption spectral chart of Example 5;

FIG. 9B is a Raman spectral chart of Example 5;

FIG. 10A is an infrared absorption spectral chart of Example 6;

FIG. 10B is a Raman spectral chart of Example 6;

FIG. 11A is an infrared absorption spectral chart of Example 7;

FIG. 11B is a Raman spectral chart of Example 7;

FIG. 12A is an infrared absorption spectral chart of Example 8;

FIG. 12B is a Raman spectral chart of Example 8;

FIG. 13A is an infrared absorption spectral chart of Example 9;

FIG. 13B is a Raman spectral chart of Example 9;

FIG. 14A is an infrared absorption spectral chart of Example 10;

FIG. 14B is a Raman spectral chart of Example 10;

FIG. 15A is an infrared absorption spectral chart of Comparative Example 1;

FIG. 15B is a Raman spectral chart of Comparative Example 1;

FIG. 16A is an infrared absorption spectral chart of Comparative Example 2;

FIG. 16B is a Raman spectral chart of Comparative Example 2;

FIG. 17A is an infrared absorption spectral chart of Reference Example 1;

FIG. 17B is a Raman spectral chart of Reference Example 1;

FIG. 18A is an infrared absorption spectral chart of Reference Example 2;

FIG. 18B is a Raman spectral chart of Reference Example 2; and

FIG. 19 is an exemplary TEM photograph of a composite material according to the present invention.

### DESCRIPTION OF EMBODIMENTS

The cathode material of the present invention contains a composite material which contains a lithium silicate crystal and a carbon material. The “composite material” herein means a material which the lithium silicate crystal and the carbon material are combined and, in particular, preferably has a sea-island structure described later.

The “cathode material” in the context of this specification is defined as a material which contains the lithium silicate crystal as an active material and the carbon material. The “cathode layer” in the context of this specification is defined as a layer formed by using the “cathode material” and a binder. An electrically conductive auxiliary may be contained in the cathode layer. Again in this specification, the “cathode” is defined as a stacked structure of a current collector and the “cathode layer” provided over the current collector.

The cathode material of the present invention concurrently satisfies the conditions (I) and (II) below:

(I) in infrared absorption spectrum of the composite material, peak(s) are found in the wave number range from 1400 cm⁻³ to 1550 cm⁻¹; and

(II) in Raman spectrum of the composite material, no peak is found in the wave number range from 1000 cm⁻¹ to 1150 cm⁻¹.

The composite material which satisfies the conditions above may be obtained by at least the manufacturing method below.

A solution which contains, at least, a compound which contains an element composing the lithium silicate and an organic compound which produces the carbon material is pyrolyzed and reacted under heating at a temperature not lower than a pyrolyzing temperature of the compound, while keeping the solution in the form of liquid droplets, to thereby obtain intermediate grains (referred to as intermediate grains, hereinafter) of the target composite material. The intermediate grains is collected and then heat-treated in an inert atmosphere or in a reductive atmosphere at 400° C. or higher and lower than the melting point of the lithium silicate, to thereby obtain the composite material. The heat treatment temperature is more preferably lower than the Tamman temperature, which is a diffusion starting temperature Td, of lithium silicate and given by Td=0.757 Tm in relation to the melting temperature Tm.

The composite material obtained by the manufacturing method described above, observed under a transmission electron microscope, shows a so-called sea-island structure, in which a plurality of regions (referred to as “island”, hereinafter) composed of the lithium silicate crystal are scattered in a discrete manner, and a carbon material lies as a bulk (matrix) between the islands.

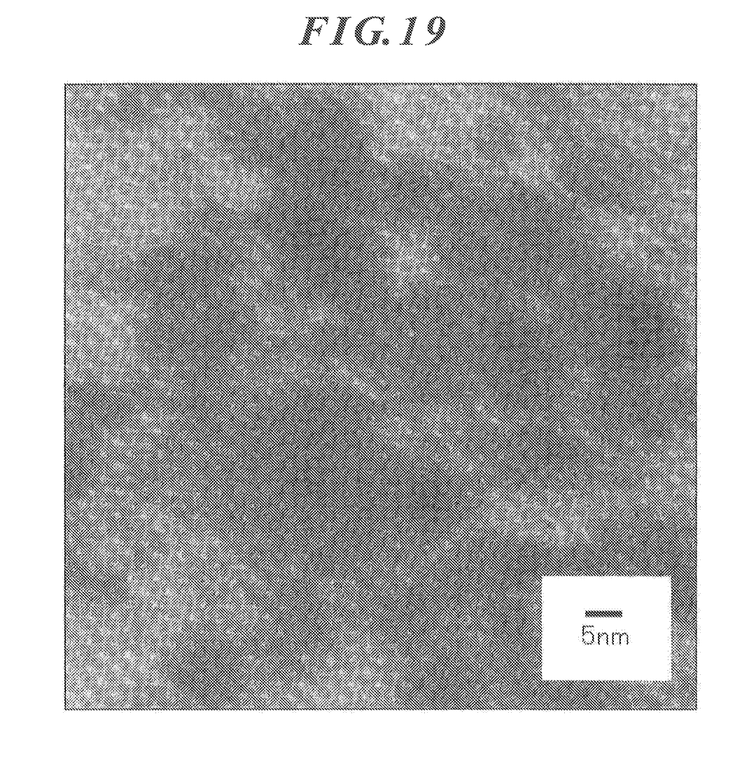

An exemplary image of a cross section of the composite grains obtained by the manufacturing method described above, which was observed under a transmission electron microscope (H-000UHR III, from Hitachi, Ltd.), is shown in FIG. 19. Regions which look dark in the figure correspond to the lithium silicate crystal, and a region which looks relatively bright around the dark regions corresponds to the carbon material. As seen in the figure, it is confirmed that the plurality of dark regions (lithium silicate crystal) are scattered in a discrete manner, and the bright region (carbon material) lies as a bulk between the dark regions.

In the manufacturing method, the diameter of the islands (lithium silicate crystal) is variable and thereby the structure of the composite material is controllable, by adjusting the temperature of heating of the liquid droplets, and the temperature and duration of succeeding heat treatment. Average value of the circle-equivalent diameter of the island is preferably smaller than 15 nm.

As a specific case, an exemplary manufacturing method making use of spray pyrolysis will be described.

A source material used for the spray pyrolysis is a solution which contains a compound which contains an element composing the lithium silicate and an organic compound which produces the carbon material. The solution is converted into liquid droplets with the aid of ultrasonic wave or a nozzle (two fluid nozzle, four fluid nozzle, etc.), the liquid droplets are then introduced into a heating furnace and heated to thereby produce the intermediate grains, and the intermediate grains is heat-treated in an inert atmosphere or in a reductive atmosphere at 400° C. or higher and lower than the melting point of the lithium silicate. The intermediate grains may be crushed if necessary, prior to the heat treatment.

For a specific case where iron lithium silicate is used, for example, a solution which contains lithium nitrate, iron (III) nitrate nonahydrate and tetraethoxysilane is further added with glucose, converted into liquid droplets using an ultrasonic atomizer or the like, the liquid droplets are introduced together with nitrogen gas as a carrier gas into a heating furnace and heated to 500 to 900° C. or around to thereby produce intermediate grains. The intermediate grains are crushed as necessary and then heat-treated in an inert atmosphere at 400° C. or above and below the melting point of the iron lithium silicate.

For another case with manganese lithium silicate, for example, a solution which contains lithium nitrate, manganese (II) nitrate hexahydrate and colloidal silica is further added with glucose, converted into liquid droplets using an ultrasonic atomizer or the like, the liquid droplets are introduced together with nitrogen as as a carrier gas into a heating furnace and heated to 500 to 900° C. or around to thereby produce intermediate grains. The intermediate grains are crushed as necessary and then heat-treated in an inert atmosphere at 400° C. or above and below the melting point of the manganese lithium silicate.

Exemplary manufacturing methods making use of roasting process will be explained.

A source materials used for the roasting process is a solution which contains a compound which contains an element composing the lithium silicate and an organic compound which produces the carbon material. The solution is converted into liquid droplets, introduced into a roasting furnace of the Ruthner Lurgi type, Chemirite type or the like, and then heated to produce intermediate grains. The source of metal oxide which contains iron element used herein is preferably pickling waste liquid after steel cleaning or iron-dissolved acid solution. The intermediate grains are then heat-treated in an inert atmosphere or in a reductive atmosphere at 400° C. or above and below the melting point of the lithium silicate, The intermediate grains may be crushed as necessary prior to the heat treatment

For a specific case where manganese lithium silicate is used, for example, a solution which contains lithium acetate, manganese (II) nitrate hexahydrate and colloidal silica is further added with glucose, converted into liquid droplets using an ultrasonic atomizer or the like, the liquid droplets are introduced into a Chemirite tape roasting furnace, for example, and heated to 500 to 900° C. or around to thereby produce intermediate grains. The intermediate grains are crushed as necessary and then heat-treated in an inert atmosphere at 400° C. or above and below the melting point of the manganese lithium silicate.

For another case with iron lithium silicate, for example, pickling waste liquid after steel cleaning (a 0.6 to 3.5 mol (Fe)/L hydrochloric acid waste liquid, for example) which contains lithium carbonate and colloidal silica is further added with glucose, converted into liquid droplets using an ultrasonic atomizer or the like, the liquid droplets are introduced into a Ruthner type roasting furnace, and heated to 500 to 900° C. to thereby produce the intermediate grains. The intermediate grains are crushed as necessary and then heat-treated in an inert atmosphere at 400° C. or above and below the melting point of the iron lithium silicate.

In the present invention, the organic compound (source material) which produces the carbon material is exemplified by ascorbic acid, monosaccharides (glucose, fructose, galactose, etc.), disaccharides (sucrose, maltose, lactose, etc.), polysaccharides (amilose, cellulose, dextrin, etc.), polyvinyl alcohol, polyethylene glycol, polypropylene glycol, polyvinyl butyral, polyvinyl pyrrolidone, phenol, hydroquinone, catechol, maleic acid, citric acid, malonic acid, ethylene glycol, triethylene glycol, diethylene glycol butyl methyl ether, triethylene glycol butyl methyl ether, tetraethylene glycol dimethyl ether, tripropylene glycol, dimethyl ether and glycerin.

Note that the present invention is not limited to the cathode material manufactured by the methods described above, and may be manufactured by any of publicly known dry process or wet process so long as the conditions (I) and (II) described above are satisfied. The methods are exemplified by flame process, solid phase process (solid phase reaction process), hydrothermal process (hydrothermal synthesis), coprecipitation process, sol-gel process, and vapor phase synthetic process (physical vapor deposition (PVD) process, chemical vapor deposition (CVD) process).

The composite material of the present invention will be explained referring to an infrared absorption spectral chart. 1 is an exemplary illustration of infrared absorption spectrum of the composite material of the present invention with the wave number (cm⁻¹) of infrared radiation irradiated on the composite material on the abscissa and with absorbance (arbitrary unit) on the ordinate. A curve 101 in the chart represents the infrared absorption spectrum (referred to as infrared absorption spectrum 101, hereinafter).

As illustrated, peak(s) appear in the wave number range from 1400 cm⁻¹ to 1550 cm⁻¹ of the measured infrared absorption spectrum of the composite material of the present invention. Appearance of the peak(s) in this range is one feature of the composite material used for the cathode material of the present invention. Only a single peak, or two or more peaks may appear in this range.

Note that, in the present invention, “peak(s) appear in the wave number range from 1400 cm⁻¹ to 1550 cm⁻¹” means that peak areas and in the infrared absorption spectral chart satisfy the relational expression (1) below:

0.02<Aₚ₁/Aₚ₂ (1)

Again in the present invention, in the infrared absorption spectral chart, the peak areas Aₚ₁ and Aₚ₂ preferably satisfy the relational expression (2) below:

0.05<Aₚ₁/Aₚ₂ (2)

The peak areas Aₚ₁ and Aₚ₂ described above are determined as follows.

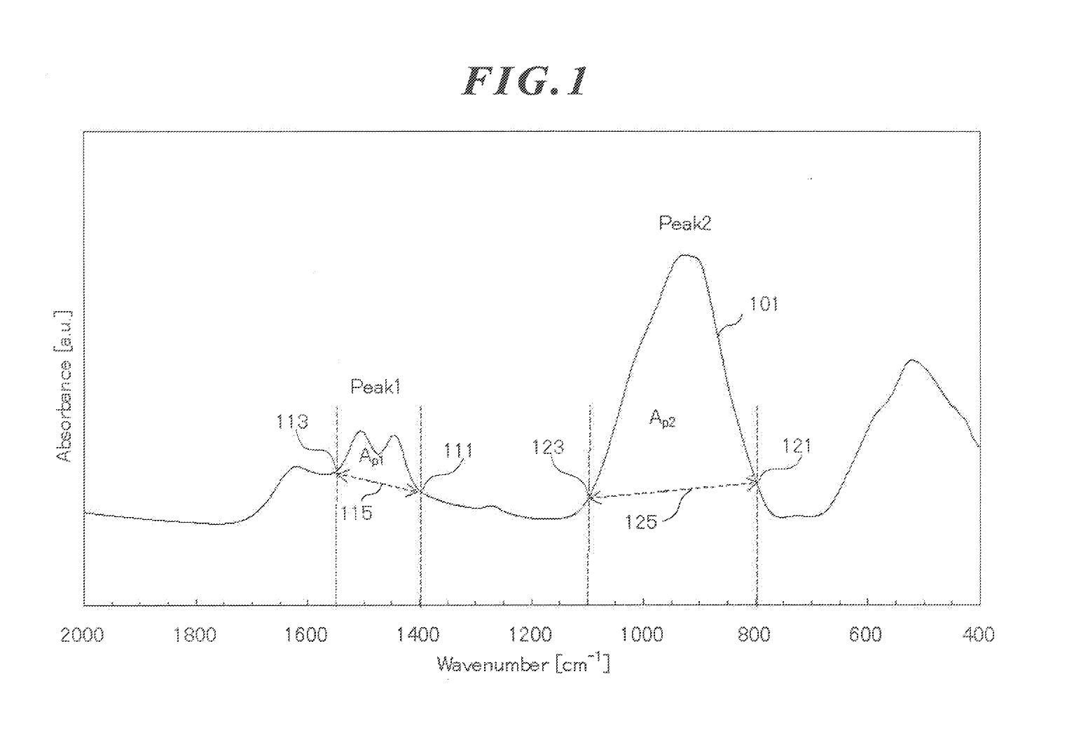

First, in the infrared absorption spectrum 101 shown in FIG. 1, a point 111 corresponding to the absorbance at a wave number of 1400 cm⁻¹ and a point 113 corresponding to the absorbance at a wave number of 1550 cm⁻¹ are connected with a first straight line 115. The area of a region surrounded by the infrared absorption spectrum 101 and the first straight line 115 is now defined as a peak area.

Similarly, in the infrared absorption spectrum 101 shown in FIG. 1, a point 121 corresponding to the absorbance at a wave number of 800 cm⁻¹ and a point 123 corresponding to the absorbance at a wave number of 1100 cm⁻¹ are connected with a second straight line 125. The area of a region surrounded by the infrared absorption spectrum 101 and the second straight line 125 is now defined as a peak area Aₚ₂.

The peak appeared in the wave number range from 800 cm⁻¹ to 1100 cm⁻¹ the infrared absorption spectrum is assigned to lithium silicate, whereas it remains unclear to what kind of bond in the composite material the peaks appeared in the wave number range from 1400 cm⁻¹ to 1550 cm⁻¹ in the infrared absorption spectrum are assignable. The present inventors, however, suppose that a bond like “carbon material —COO-M (M represents a metal ion including Li)” would be formed at the boundary between the lithium silicate crystal and the carbon material. The present inventors also suppose that, by using the composite material having such bond as the cathode material for lithium ion secondary battery, the lithium ion secondary battery successfully achieved large capacity and large energy density as a consequence.

Note that, in the wave number range from 1400 cm⁻¹ to 1550 cm⁻¹ of the infrared absorption spectrum, a similar peak is observed also when carbonate ion is contained.

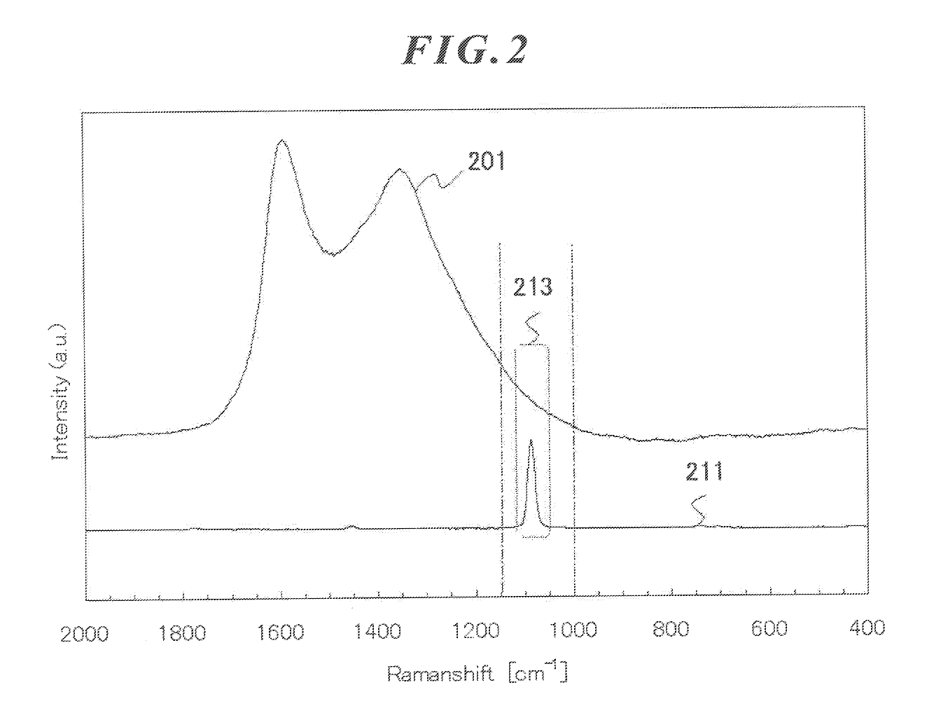

FIG. 2 shows a Raman spectrum 201 obtained by Raman spectrometry of the composite material. In FIG. 2, difference (Raman shift (cm⁻¹)) between the wave number of Raman scattered light emitted from the composite material irradiated by laser light and the wave number of the incident light is plotted on the abscissa, and Raman scattering intensity (arbitrary unit) is plotted on the ordinate. For reference, FIG. 2 also shows a Raman spectrum 211 obtained from a similar measurement made on lithium carbonate.

As illustrated in FIG. 2, the Raman spectrum 211 of lithium carbonate shows a peak 213 assigned to the symmetrical stretching vibration ξ1 of carbonate ion (CO₃²⁻) in the wave number range from (symmetrical stretching vibration ξ1 of lithium carbonate ion (CO₃²⁻)) corresponding to the peak 213 in the Raman spectrum 211. Note that “shows no peak” means that the signal-to-noise ratio (S/N) is given by S/N═N/N. Accordingly, in the present invention, the peaks which appear in the wave number range from 1400 cm⁻¹ to 1550 cm⁻¹ of the infrared absorption spectrum are supposed to be not assigned to carbonate ion.

As described above, the composite material of the present invention shows the peaks in the wave number range from 1400 cm⁻¹ to 1550 cm⁻¹ of the infrared absorption spectrum and shows no peak in the wave number range from 1000 cm⁻¹ to 1150 cm⁻¹ of the Raman spectrum. In other words, the cathode material of the present invention concurrently satisfies the conditions (I) and (II) above, and is, as described later, capable of achieving larger capacity and larger energy density as compared with the conventional lithium ion secondary battery using lithium silicate.

The composite material of the present invention achieves a large capacity ascribable to a reaction of lithium silicate participated by a single or more electrons, preferably when the peak area ratio Aₚ₁/Aₚ₂ in the infrared absorption spectral chart satisfies the relational expression (1) shown above, and more preferably the relational expression (2) shown above. If the peak area ratio of Aₚ₁/Aₚ₂ is 0.02 or smaller, a satisfactory level of characteristics will not always be achievable. The peak area ratio Aₚ₁/Aₚ₂ is preferably 0.05 or larger. As described above, assuming that the peaks which appear in the wave number range from 1400 cm⁻¹ to 1550 cm⁻¹ of the infrared absorption spectrum are assigned to the bond formed at the boundary between the lithium silicate crystal and the carbon material, the peak area ratio Aₚ₁/Aₚ₂ will be in relation to the ratio of the bond. It is accordingly supposed that the larger the area ratio, the more contributive to good characteristics. While the upper limit of the peak area ratio Aₚ₁/Aₚ₂ is not specifically limited, there is a tendency that the characteristics no longer improve at a value of 0.18 or above. The peak area ratio Aₚ₁/Aₚ₂ is therefore, preferably smaller than 0.18.

Next, an exemplary configuration of the cathode material of the present invention will be explained.

As described above, the cathode material of the present invention has the sea-island structure configured by the lithium silicate crystal and the carbon material. The lithium silicate crystal is a crystal of lithium silicate which contains lithium, transition metal, silicon and oxygen, or a crystal of a derivative derived from the basic structure of lithium silicate by element substitution or compositional change. The transition metal herein is exemplified by iron (Fe), manganese (Mn), cobalt (Co) and nickel (Ni) which are characterized by variable valency. The lithium silicate in the present invention may be represented by compositional formula Li₂MSiO₄ (where, M represents one or more transition metal elements), and is specifically exemplified by Li₂FeSiO₄, Li₂MnSiO₄, Li₂CoSiO₄ and Li₂NiSiO₄.

The carbon material in the present invention contains an elemental carbon. The carbon material is preferably a porous carbon,

It is further preferable that the carbon material for the present invention, an XPS spectral chart obtained by X-ray photoelectron spectroscopy (XPS) shows C₁₈ peaks which contain not only an SP² peak (284.3 eV) assigned to the graphite skeleton and an SP³ peak (285.3 eV) assigned to the diamond skeleton, but also a shoulder peak located on the higher energy side of them.

The shoulder peak is ascribable to a functional group bound to the carbon skeleton and is ascribable to a terminal functional group such as hydroxy group (—OH), carboxyl group (—COOH), carbonyl group (—C═O) or the like. The terminal functional group serves as a hydrophilic functional group (also referred to as polar group). By using the carbon material which shows the shoulder peak for the present invention, the carbon material is supposed to be enhanced in wettability with the solvent of electrolyte (polar solvent), by the contribution of the terminal functional group, and can therefore allow the electrolytic solution to readily permeate throughout fine structural portions of the cathode. By facilitating the permeation of the electrolytic solution, a large capacity is supposed to be readily achievable.

The composite material which shows the shoulder peak may be obtained by the manufacturing method described above, although the composite material may be produced alternatively by using a steam-activated carbon material.

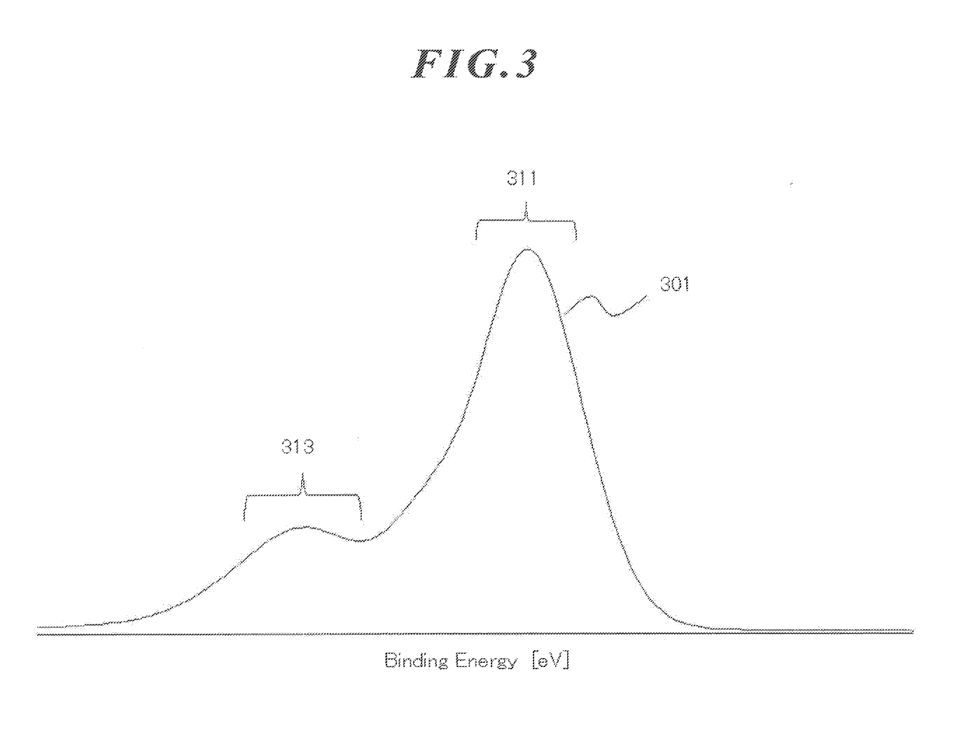

FIG. 3 illustrates an exemplary XPS spectral chart obtained from measurement of the cathode material of the present invention. A C_{1S} peak 301 not only includes a peak 311 which is separable into an SP² peak and an SP³ peak but also a shoulder peak 313 located on the higher energy side of the peak 311. The shoulder peak 313 is separable, for example, into a dummy peak 1 which is assigned to C in C—OH and a dummy peak 2 which is assigned to C in C—O and COOH.

When XPS is measured, gold is measured concurrently with a sample to be measured and the bond energy (eV) of the C peak is calibrated with an Au 4f_{7/2} peak (84.0 eV). More specifically, the Au 4f_{7/2} peak is adjusted to 84.0 eV and the C₁₈ peak is then shifted by the same amount of adjustment of the Au 4f_{7/2} peak,

Peaks are separated after the background is eliminated from the XPS spectrum. Peak fitting is carried out using the SP² peak, the SP³ peak, the dummy peak 1 and the dummy peak 2 while assuming that each of the four peaks follows the Gauss-Lorentz distribution. The SP² peak and the SP³ peak are fitted while fixing the SP² peak at a peak position (bond energy) of 284.3 eV and the SP³ peak at a peak position (bond energy) of 285.3 eV, leaving the peak width and the peak height variable. The dummy peak 1 and the dummy peak 2 are fitted while leaving the peak position, the peak width and the peak height variable.

Now, let the peak area of Cᵢₛ measured as described above be S, SP² peak area be S_{SP2}, and the SP³ peak area be S_{SP3}. In the present invention, presence of the shoulder peak is determined when a ratio S_{R}/S, which represents a ratio of remainder S_{R} obtained by subtracting the SP² peak area S_{SP2} and the SP³ peak area S_{SP3} from the C_{1S} peak area S (=S−S_{SP2}−S_{SP3}) relative to the C_{1S} peak area S, is 0.15 or larger.

In the present invention, the ratio S_{R}/S preferably satisfies 0.25≦S_{R}/S≦0.40. If S_{R}/S is smaller than 0.25, a longer time may be necessary for the electrolytic solution to permeate. Meanwhile, if S_{R}/S exceeds 0.40, a large capacity will not always be achieved. This is supposedly because the electric conductivity degrades due to an increased ratio of content of hydrophilic groups in the carbon skeleton. Since the carbon material which contains the hydrophilic groups is poor in the electric conductivity, so that if the ratio of content of the hydrophilic functional group increases, the active material becomes less electrically conductive with the current collector and the electrically conductive auxiliary, and this supposedly makes it difficult to achieve a large capacity in some cases.

The content of carbon material in the composite material of the present invention is preferably 2% by mass or more and 25% by mass or less. If the content of carbon material is less than 2% by mass, an electron conduction path towards the current collector may be ensured only to an insufficient degree, and therefore good battery characteristics will not always be obtained. If the content of carbon material exceeds 25% by mass, the ratio of content of active material in a manufactured electrode will decrease, and therefore a high battery capacity will not always be obtained depending on the way of designing the battery and purposes. By adjusting the content of carbon material in the above-described range, good battery performances may easily be ensured and thereby a range of selection of battery design may be widened.

Next, an exemplary cathode layer using the cathode material of the present invention will be explained.

The cathode material of the present invention may be mixed with a binder, to thereby form the cathode layer. The cathode layer may be configured to contain an electrically conductive auxiliary. The cathode layer has a structure with a void into which the electrolytic solution can enter.

The binder (also referred to as adhesive agent) serves to connect (bond) the active material and the electrically conductive auxiliary. The binder used in the present invention is generally selectable from those used for manufacturing the cathode of the lithium ion secondary battery. The binder is preferably any of those chemically and electrochemically stable against the electrolyte of the lithium ion secondary battery and the solvent of the electrolyte. The binder may be either of thermoplastic resin and thermosetting resin. For example, the binder is exemplified by polyolefins including polyethylene and polypropylene; fluorine-containing resins including polytetrafluoroethylene (PTE), polyvinylidene fluoride (PVDF) tetrafluoroethylene-hexafluoroethylene copolymer, tetrafluoroethylene-hexafluoropropylene copolymer (FEP), tetrafluoroethylene-perfluoroalkyl vinyl ether copolymer (PFA) vinylidene fluoride-hexafluoropropylene copolymer, vinylidene fluoride-chlorotrifluoroethylene copolymer, ethylene-tetrafluoroethylene copolymer (ETFE resin), polychlorotrifluoroethylene (PCTFE), vinylidene fluoride-pentafluoropropylene copolymer, propylene-tetrafluoroethylene copolymer, ethylene-chlorotrifluoroethylene copolymer (ECTFE), vinylidene fluoride-hexafluoropropylene-tetrafluoroethylene copolymer, and vinylidene fluoride-perfluoromethyl vinyl ether-tetrafluoroethylene copolymer; styrene butadiene rubber (SBR); ethylene-acrylic acid copolymer or Na⁺ ion crosslinked product of the copolymer; ethylene-methacrylic acid copolymer or Na⁺ ion crosslinked product of the copolymer; ethylene-methyl acrylate copolymer or Na⁺ ion crosslinked product of the copolymer; ethylene-methyl methacrylate copolymer or Na⁺ ion crosslinked product of the copolymer; and carboxymethyl cellulose. Two or more species of the materials exemplified above as the binder may be used in combination. Among the materials exemplified as the binder, particularly preferable are PVDF and PTFE. The amount of use of the binder is preferably 1% by mass to 20% by mass or around of the total amount of cathode material.

The electrically conductive auxiliary is selectable without special limitation from electron conductive materials which are substantially and chemically stable. Examples include carbon materials such as graphites including natural graphite (flaky graphite, etc.) and synthetic graphite; acetylene black; Ketjen black; carbon blacks including channel black, furnace black, lamp black, and thermal black; carbon fiber; and also include electro-conductive fibers including metal fiber; carbon fluoride; metal powders of aluminum, etc.; zinc oxide; electro-conductive whiskers of potassium titanate, etc.; electro-conductive metal oxides including titanium oxide; and organic electro-conductive materials including polyphenylene derivatives. Only a single species of the electrically conductive auxiliary may be used independently, or two or more species of which may be used in combination. Among the materials exemplified above as the electrically conductive auxiliary, particularly preferable is a carbon raw material such as acetylene black, Ketjen black or carbon black. The amount of use of the electrically conductive auxiliary is preferably 25% a by mass or less of the total amount of cathode material.

Next, an exemplary cathode of the present invention will be explained.

The cathode of the present invention may be formed by combining the above-described cathode layer and the current collector. More specifically, the cathode layer may be formed on the current collector, to thereby produce the cathode.

A metal foil may be used as the current collector. More specifically, an electro-conductive metal foil may be used. Aluminum or aluminum alloy foil, for example, may be used as the metal foil. The thickness of the current collector may be set to 5 μm to 50 μm.

Also a metal mesh may be used as the current collector. The cathode layer which contains at least the cathode material of the present invention and the binder is formed on the metal mesh, to thereby produce the cathode.

The cathode of the present invention may further be combined with an anode, a separator, and a non-aqueous electrolytic solution, to thereby produce the lithium ion secondary battery.

The anode usable herein is such as having an anode layer, which contains an active material for anode, provided on a current collector.

The anode layer usable herein is such as containing an active material for anode (referred to as anode active material, hereinafter) and an optional binder.

The anode active material usable herein is any material capable of allowing metallic lithium or lithium ion to intercalate and deintercalate. More specifically, the anode active material usable herein includes a carbon raw material such as graphite, pyrolytic carbons, cokes, glassy carbons, sintered product of organic polymer compound, mesocarbon microbead, carbon fiber and activated carbon. Also compounds such as alloy of Si, Sn or In; oxide of Si, Sn or Ti capable of allowing charge and discharge at a low potential which is equivalent to that of lithium; and nitride of Li and Co such as Li_{2.6}Co_{0.4}N, may be used as the anode active material. A part of graphite may further be replaced with a metal alloyable with lithium or with an oxide, to thereby produce the anode active material. Use of graphite as the anode active material is preferable since the charge potential of the cathode will be easy to control. This is because when graphite is used as the anode active material, the voltage in the full-charge state may be assumed as approximately 0.1 V with reference to lithium, so that the potential of the cathode may be calculated, for convenience, by adding 0.1 V to the battery voltage.

As the current collector, usable for example is a metal foil made of simple metal or an alloy of copper, nickel and titanium; and stainless steel. Among the metal foils exemplified above as the current collector, copper or copper alloy is particularly preferable. Preferable examples of metals to be alloyed with copper include zinc, nickel, tin and aluminum. Besides the metals to be alloyed with copper, a small amount of iron, phosphorus, lead, manganese, titanium, chromium, silicon or arsenic may be used additionally.

The separator usable herein is any of films having large ion permeability, predetermined level of mechanical strength, and insulating property. Materials for composing the separator are exemplified by olefinic polymer, fluorine-containing polymer, cellulosic polymer, polyimide, nylon, glass fiber, and alumina fiber. Available form of the separator is exemplified by non-woven fabric, woven fabric and micro-porous film. In particular, preferable examples of materials for composing the separator include polypropylene, polyethylene, mixture of polypropylene and polyethylene, mixture of polypropylene and polytetrafluoroethylene (PTFE), and mixture of polyethylene and polytetrafluoroethylene (PTFE). The available form of the separator is preferably a micro-porous film, and more preferably the micro-porous film with a pore size of 0.01 μm to 1 μm, and a thickness of 5 μm to 50 μm. The micro-porous film may be a single film, or may be a composite film composed of two or more layers having different properties such as pore geometry, density and quality of material. For example, a composite film configured, by bonding a polyethylene film and a polypropylene film may be used as the composite film.

As the non-aqueous electrolytic solution, usable is an electrolytic solution composed of an electrolyte (supporting salt) and a non-aqueous solvent.

Lithium salt is mainly used as the electrolyte (supporting salt). The lithium salt usable in this embodiment is exemplified by LiClO₄, LiBF₄, LiPF₃CO₂, LiSbF₆, LiB₁₀Cl₁₀, fluorosulfonate salt represented by LiOSO₂CₙF₂ₙ₊₁ (n represents a positive integer of 6 or smaller), imlde salt represented by LiN(SO₂CₙF₂ₙ₊₁) (SO₂CₘF₂ₘ₊₁) (each of m and n independently represents a positive integer of 6 or smaller), methide salt represented by LiC(SO₂CₚF₂ₚ₊₁) (SO₂C_{q}F_{2q+1}) (SO₂CᵣF₂ᵣ₊₁) (each of p, q and r independently represents a positive integer of 6 or smaller), lithium salt of lower aliphatic carboxylic acid, LiAlCl₄, LiCl, LiBr, LiI, chloroborane lithium and lithium tetraphenylborate, and only a single species of which may be used independently or two or more species of which may be used in a mixed manner. Among the lithium salts exemplified above, LiBF₄ and/or LiPF₆ in the dissolved form are preferably used. Concentration of the electrolyte (supporting salt) is preferably 0.2 mol to 3 mol per one liter of electrolytic solution, although not specifically be limited thereto.

The non-aqueous solvent is exemplified by aprotic organic solvents which include propylene carbonate, ethylene carbonate, butylene carbonate, chloroethylene carbonate, trifluoromethyl ethylene carbonate, difluoromethyl ethylene carbonate, monofluoromethyl ethylene carbonate, hexafluoromethyl acetate, trifluoromethyl acetate, dimethyl carbonate, diethyl carbonate, methylethyl carbonate, γ-butyrolactone, methyl formate, methyl acetate, 1,2-dimethoxyethane, tetrahydrofuran, 2-methyltetrahydrofuran, dimethylsulfoxide, 1,3-dioxolane, 2,2-bis(trifluoromethyl)-1,3-dioxolane, formamide, dimethyl formamide, dioxolane, dioxane, acetonitrile, nitromethane, ethyl monoglyme, phosphoric triester, boric triester, trimethoxymethane, dioxolane derivative, sulfolane, 3-methyl-2-oxazolidinone, 3-alkylsydnone (alkyl group is a propyl group, isopropyl group, butyl group, etc.), propylene carbonate derivative, tetrahydrofuran derivative, ethyl ether and 1,3-propane sultone; and ionic liquid; and only a single species of which may be used independently or two or more species of which may be used in a mixed manner. Among the non-aqueous solvents exemplified above, the carbonate-based solvents are preferable and it is particularly preferable to use cyclic carbonate and acyclic carbonate in a mixed manner. The cyclic carbonate is preferably ethylene carbonate or propylene carbonate. The acyclic carbonate is preferably diethyl carbonate, dimethyl carbonate or methylethyl carbonate. The ionic liquid is preferable from the viewpoint of high potential window and heat resistance.

The amount of the non-aqueous electrolytic solution composing the lithium ion secondary battery may be determined depending on the amounts of cathode material and anode material, size of battery and so forth, without special limitation,

Besides the non-aqueous electrolytic solution, a solid electrolyte may be used in combination. The solid electrolyte includes inorganic solid electrolyte and organic solid electrolyte. The inorganic solid electrolyte is exemplified by nitride, halide and oxoate of lithium. Among the materials exemplified as the inorganic solid electrolyte, preferable are Li₃N, LiI, Li₅NI₂, Li₃N-LiI-LiOH, Li₄SiO₄, Li₄SiO₄-LiI-LiOH, xLi₃PO₄-(1-x)Li₄SiO₄, Li₂SiS₃, and phosphorus sulfide compounds. The organic solid electrolyte is exemplified by polyethylene oxide derivative or polymer containing such derivative, polypropylene oxide derivative or polymer containing such derivative, polymer containing ion dissociative group, mixture of polymer containing ion dissociative group and aprotic electrolytic solution, phosphoric ester polymer, and polymer matrix material containing aprotic polar solvent. The organic solid electrolyte may also be embodied by adding polyacrylonitrile to an electrolytic solution. Still alternatively, the inorganic solid electrolyte and the organic solid electrolyte may be used in combination.

### EXAMPLE

The present invention will now be specifically explained below, referring to Examples and Comparative Examples.

### Example 1

A composite material configured by an iron lithium silicate (Li₂FeSiO₄) crystal and a carbon material was manufactured described below.

Materials used for composing iron lithium silicate were lithium nitrate (LiNO₃), iron (III) nitrate nonahydrate (Fe(NO₃)₃.9H₂O) and tetraethoxysilane (referred to as TEOS, hereinafter) (Si(OC₂H₄)₄). Into an aqueous solution which contains the materials for composing iron lithium silicate respectively weighed so as to attain a stoichiometric composition of Li₂FeSiO₄, glucose was added as a carbon source. The amount of addition of glucose was equimolar to lithium nitrate.

The thus obtained solution was converted into liquid droplets using an ultrasonic atomizer, the liquid droplets were introduced together with nitrogen gas as a carrier gas into an electric furnace heated at a preset temperature of 800° C., and then pyrolyzed and reacted to thereby obtain an intermediate of the composite material (spray pyrolysis process).

The thus obtained intermediate was wet ground using a planetary hall mill. The grinding was conducted under conditions including a rotation rate of 200 rpm and a grinding time of 270 minutes. The grinding was conducted using zirconia balls of 0.5 mm in diameter, and ethanol as a solvent (grinding process).

The thus ground intermediate was heat-treated in a batch furnace. The heat treatment was conducted in an argon atmosphere containing 1 volt hydrogen at 500° C. for 10 hours (heat treatment process).

### Example 2

A composite material configured by the iron lithium silicate (Li₂FeSiO₄) crystal and the carbon material was manufactured in the same way as Example 1 except for the heat treatment process. The heat treatment was conducted in an argon atmosphere containing 1 vol % hydrogen at 700° C. for 2 hours.

### Example 3

A composite material configured by an iron lithium silicate (Li₂(Fe_{0.9}Mg_{0.1})SiO₄) crystal of which a part of iron was substituted by magnesium and a carbon material was manufactured. Materials used for composing iron lithium silicate were lithium nitrate, iron (III) nitrate nonahydrate, TEOS and magnesium nitrate hexahydrate (Mg(NO₃)₂.6H₂O). Into an aqueous solution which contains the materials for composing iron lithium silicate respectively weighed so as to attain a stoichiometric composition of Li₂(Fe_{0.9}Mg_{0.1})SiO₄, dextrin (carbon source) in an equimolar amount with lithium nitrate was added, followed thereafter by the spray pyrolysis process, the grinding process, and the heat treatment process in the same way as Example 1.

### Example 4

A composite material configured by an iron lithium silicate (Li₂(Fe_{0.9}Zn_{0.1})SiO₄) crystal of which a part of iron was substituted by zinc and a carbon material was manufactured. Zinc nitrate hexahydrate (Zn(NO₃)₂.6H₂O) was used as the source material in place of magnesium nitrate hexahydrate, and ascorbic acid in an equimolar amount with lithium nitrate was used as the carbon source, followed thereafter by the spray pyrolysis process, the grinding process, and the heat treatment process in the same way as Example 3.

### Example 5

A composite material configured by a manganese lithium silicate (Li₂MnSiO₄) crystal and a carbon material was manufactured as follows.

Materials used for composing manganese lithium silicate were lithium nitrate, manganese nitrate hexahydrate (Mn(NO₃).6H₂O) and colloidal silica (silicon dioxide: SiO₂). Into an aqueous solution which contains the materials for composing manganese lithium silicate respectively weighed so as to attain a stoichiometric composition of Li₂MnSiO₄, glucose was added as the carbon source. The amount of addition of glucose was equimolar to lithium nitrate.

The thus obtained solution was converted into liquid droplets using an ultrasonic atomizer, the liquid droplets were introduced together with nitrogen gas as a carrier gas into an electric furnace heated at a preset temperature of 600° C., and then pyrolyzed and reacted to thereby obtain an intermediate of the composite material (spray pyrolysis process).

The thus obtained intermediate was wet ground using a planetary ball mill. The grinding was conducted under conditions including a rotation rate of 200 rpm and a grinding time of 270 minutes. The grinding was conducted using zirconia balls of 0.5 mm in diameter, and ethanol as a solvent (grinding process).

The thus ground intermediate was heat-treated in a batch furnace. The heat treatment was conducted in an argon atmosphere containing 1 vol % hydrogen at 700° C. for 2 hours (heat treatment process).

### Example 6

A composite material configured by a manganese magnesium lithium silicate (Li₂(Mn_{0.9}Mg_{0.1})SiO₄) crystal of which a part of manganese was substituted by magnesium and a carbon material was manufactured. Materials used for composing manganese lithium silicate were lithium nitrate, manganese nitrate hexahydrate, colloidal silica and magnesium nitrate hexahydrate. Into an aqueous solution which contains the materials for composing manganese magnesium lithium silicate respectively weighed so as to attain a stoichiometric composition of Li₂(Mn_{0.9}Mg_{0.1})SiO₄, dextrin in an equimolar amount with lithium nitrate was added as the carbon source, followed thereafter by the spray pyrolysis process, the grinding process, and the heat treatment process in the same way as Example 5.

### Example 7

A composite material configured by a manganese zinc lithium silicate (Li₂(Mn_{0.9}Zn_{0.1})SiO₄) crystal of which a part of manganese was substituted by zinc and a carbon material was manufactured. The spray pyrolysis process, the grinding process and the heat treatment process were conducted in the same way as Example 6, except that zinc nitrate hexahydrate was used in place of magnesium nitrate hexahydrate and ascorbic acid in an equimolar amount with lithium nitrate was added as the carbon source.

### Example 8

A composite material configured by a manganese nickel lithium silicate (Li₂(Mn_{0.9}Ni_{0.1})SiO₄) crystal of which a part of manganese was substituted by nickel and a carbon material was manufactured. The spray pyrolysis process, the grinding process and the heat treatment process were conducted in the same way as Example 6, except that nickel (II) nitrate hexahydrate (Ni(NO₃)₂.6H₂O) was used in place of magnesium nitrate hexahydrate as the source material.

### Example 9

A composite material configured by a manganese copper lithium silicate (Li₂(Mn_{0.9}Cu_{0.1})SiO₄) crystal of which a part of manganese was substituted by copper and a carbon material was manufactured. The spray pyrolysis process, the grinding process, and the heat treatment process were conducted in the same way as Example 6, except that copper (II) nitrate trihydrate (Cu(NO₃)₂.3H₂O) was used in place of magnesium nitrate hexahydrate as the source material.

### Example 10

A composite material configured by an iron manganes silicate (Li₂(Mn_{0.5}Fe_{0.5})SiO₄) crystal of which a part of iron was substituted by manganese and a carbon material was manufactured. The spray pyrolysis process, the grinding process and the heat treatment process were conducted in the same way as Example 3, except that manganese (II) nitrate hexahydrate was used in place of magnesium nitrate hexahydrate as the source material so as to attain a stoichiometric composition of Li₂(Mn_{0.5}Fe_{0.5})SiO₄.

### Comparative Example 1

A composite material of an iron lithium silicate (Li₂FeSiO₄) crystal and a carbon material was manufactured by a conventionally known manufacturing method. Source materials used for composing iron lithium silicate were lithium nitrate, iron (III) nitrate nonahydrate and TEOS, which were respectively weighed so as to attain a stoichiometric composition of Li₂FeSiO₄, and dissolved into water. The solution was not added with a carbon source.

The thus obtained solution was converted into liquid droplets using an ultrasonic atomizer, the liquid droplets were introduced together with nitrogen gas as a carrier gas into an electric furnace heated at a preset temperature of 800° C., and then pyrolyzed and reacted to thereby obtain an intermediate of iron lithium silicate (spray pyrolysis process).

The thus obtained intermediate was wet ground using a planetary ball mill. The grinding was conducted under conditions including a rotation rate of 200 rpm and a grinding time of 270 minutes. The grinding was conducted using zirconia balls of 0.5 mm in diameter and ethanol as the solvent (grinding process).

The thus ground intermediate was heat-treated in a batch furnace. The heat treatment was conducted in an argon atmosphere containing 1 vol % hydrogen at 700° C. for 2 hours (first heat treatment process).

Next, the obtained crystal powder of iron lithium silicate and glucose were respectively weighed so as to attain a molar ratio of 2:1, and mixed by adding water (solvent). The thus obtained mixture was subjected to a second heat treatment using a batch furnace. The second heat treatment was conducted in a nitrogen atmosphere at 100° C. for one hour, followed by heat treatment at 500° C. for 4 hours (second heat treatment process).

### Comparative Example 2

A composite material of an iron lithium silicate (Li₂FeSiO₄) crystal and a carbon material was manufactured by a conventionally known manufacturing method.

Source materials used for composing iron lithium silicate were lithium carbonate (Li₂CO₃), iron (II) oxalate dihydrate (Fe (C₂O₄). 2H₂O) and colloidal silica, which were respectively weighed so as to attain a stoichiometric composition of Li₂FeSiO₄. Powders of the source materials were mixed and wet-ground using a planetary ball mill. The grinding was conducted under conditions including a rotation rate of 200 rpm and a grinding time of 72 hours. The grinding was conducted using zirconia balls of 1 mm in diameter and ethanol as the solvent.

The thus ground powder was heat-treated in a batch furnace. The heat treatment was conducted in an argon atmosphere containing 1 vol % hydrogen at 800° C. for 6 hours. The thus obtained crystal powder of iron lithium silicate was mixed with glucose in the same way as Comparative Example 1, and subjected to the second heat treatment.

### Reference Example 1

The crystal powder of iron lithium silicate after the first heat treatment process in Comparative Example 1 (that is, the powder before being mixed with glucose) was added with lithium carbonate powder (from Junsei Chemical Co., Ltd.; purity=99.0%) to thereby prepare a mixture.

### Reference Example 2

The lithium carbonate powder (from Junsei Chemical. Co., Ltd.; purity=99.0%) was prepared.

### (Phase Identification)

The samples prepared in Example 1 to Example 10, Comparative Example 1 and Comparative Example 2, and iron lithium silicate used in Reference Example 1 were identified by using a powder X-ray diffractometer (powder X-ray diffractometer Ultima II, from Rigaku Corporation). From results of the X-ray diffractometry, the samples prepared in Example 1 to Example 10, Comparative Example 1 and Comparative Example 2, and the sample used in Reference Example 1 were respectively found to have phases listed in Table 1.

### (Infrared Absorption Spectrum)

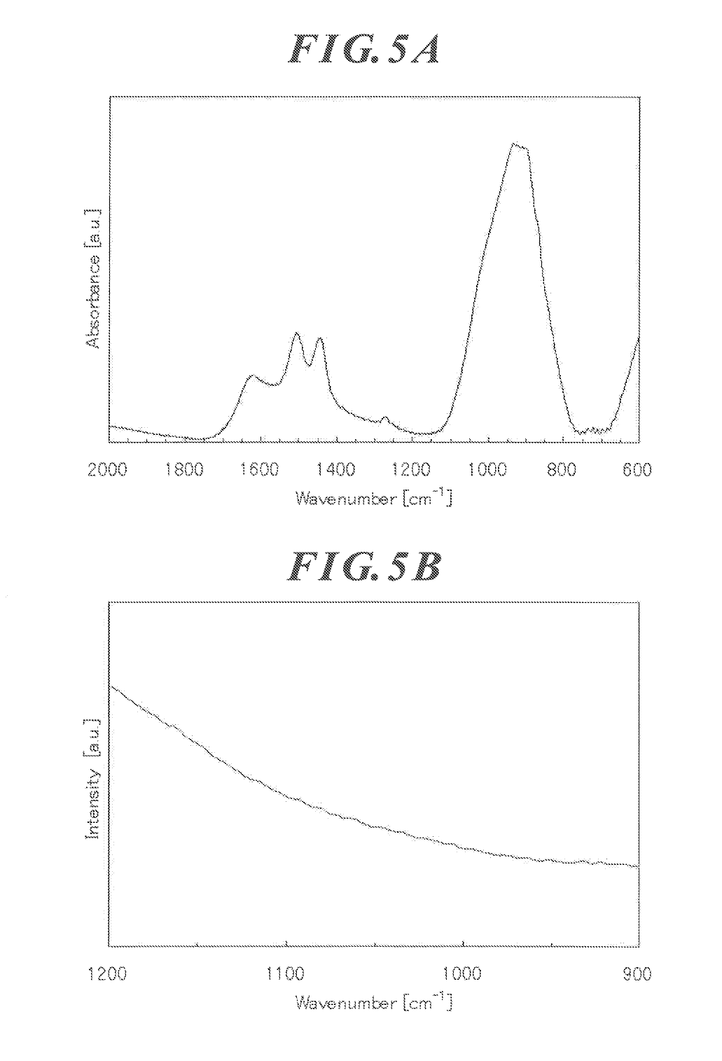

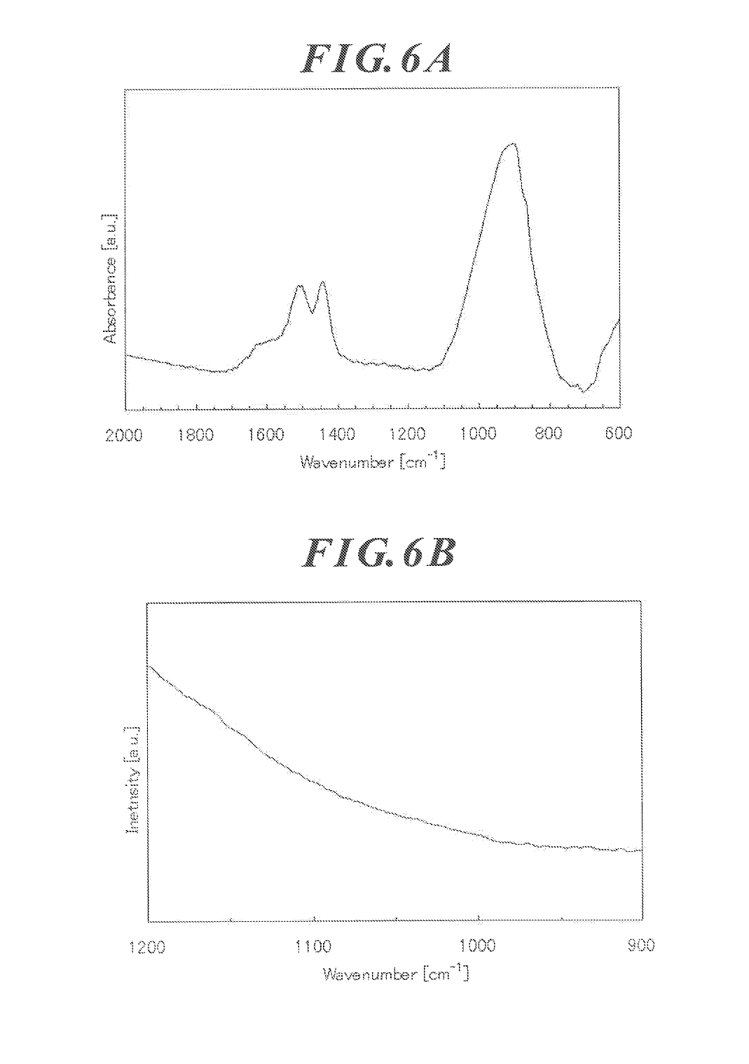

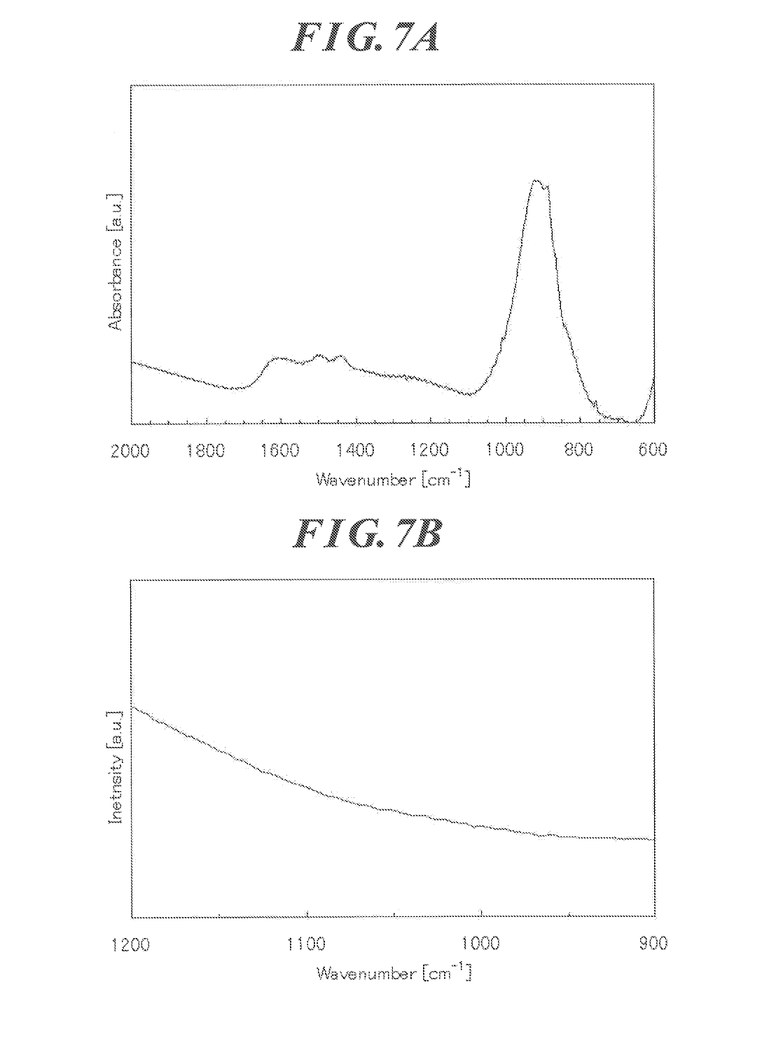

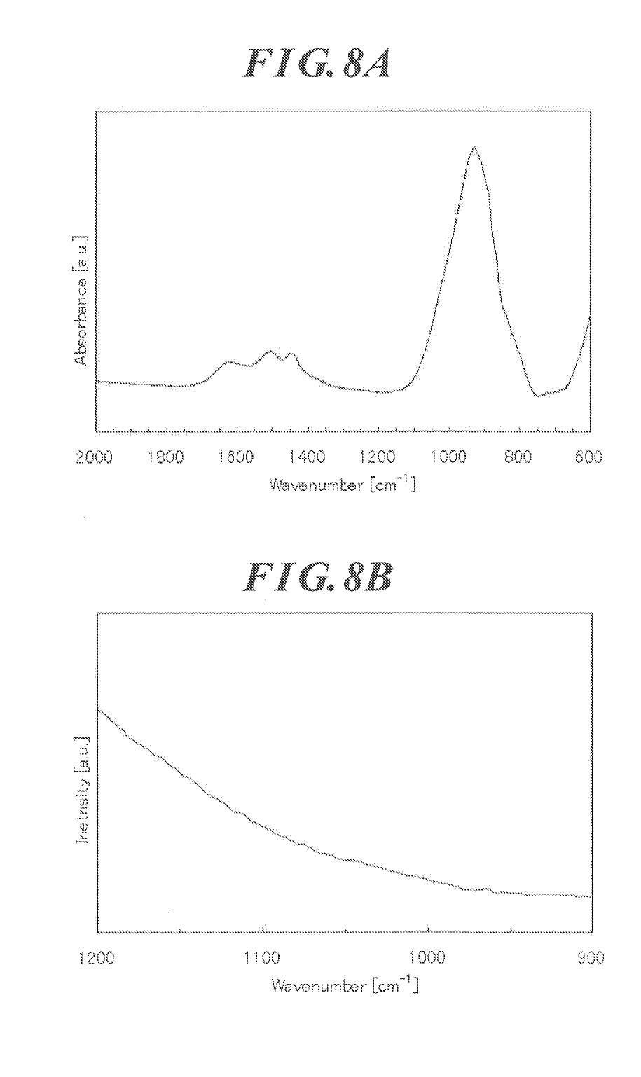

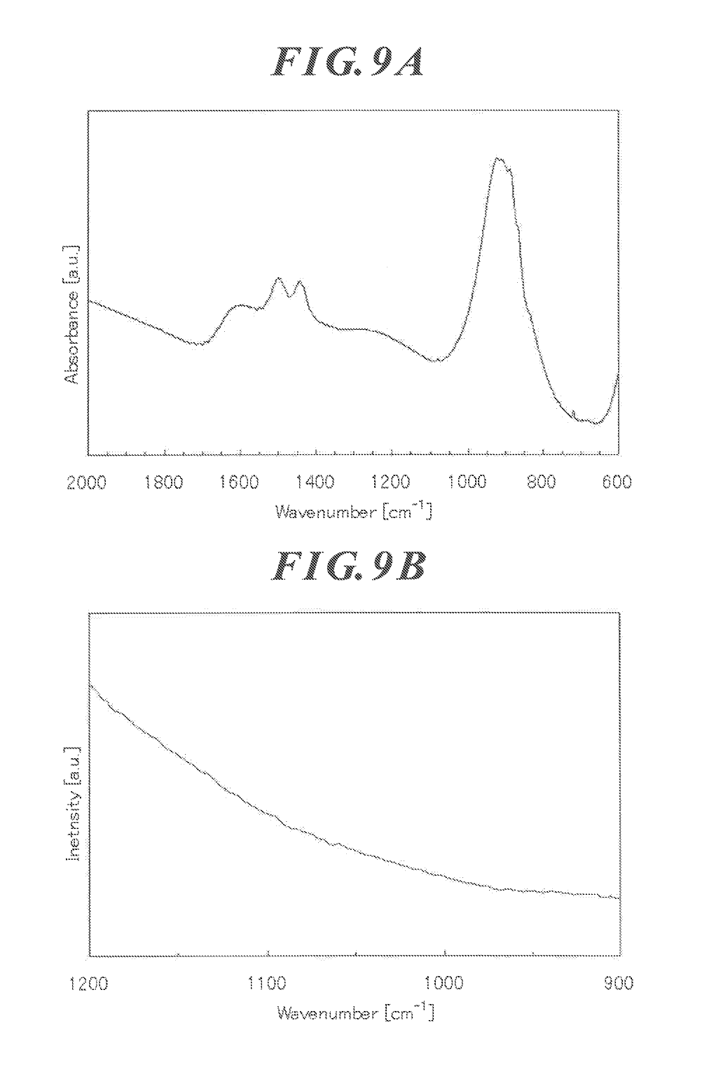

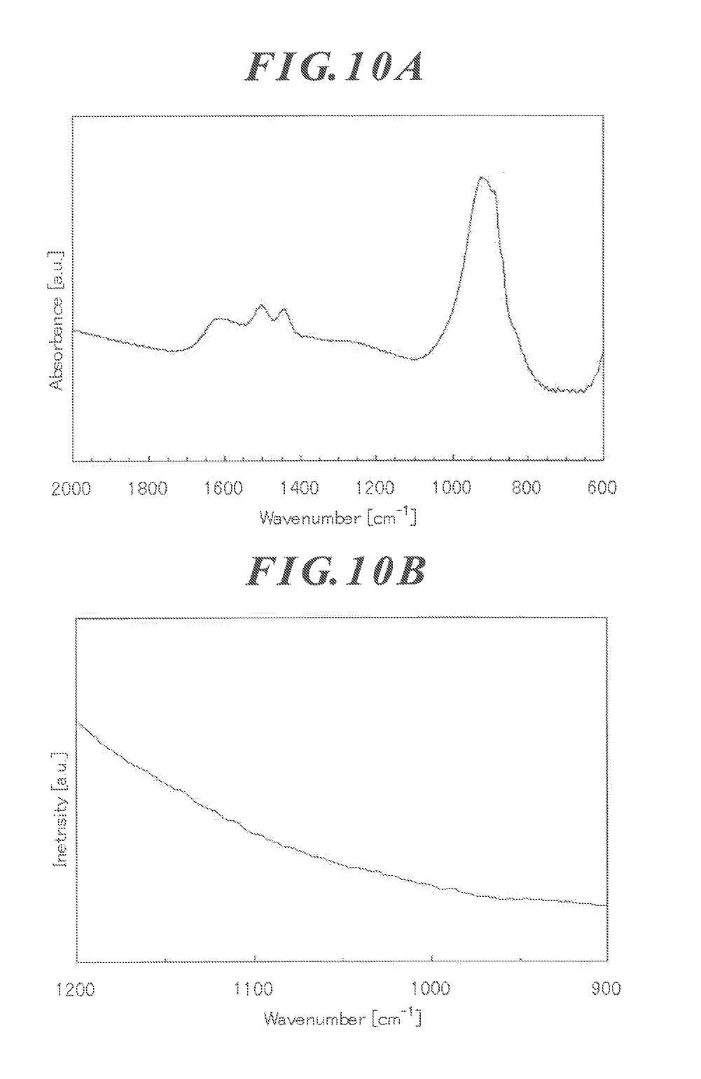

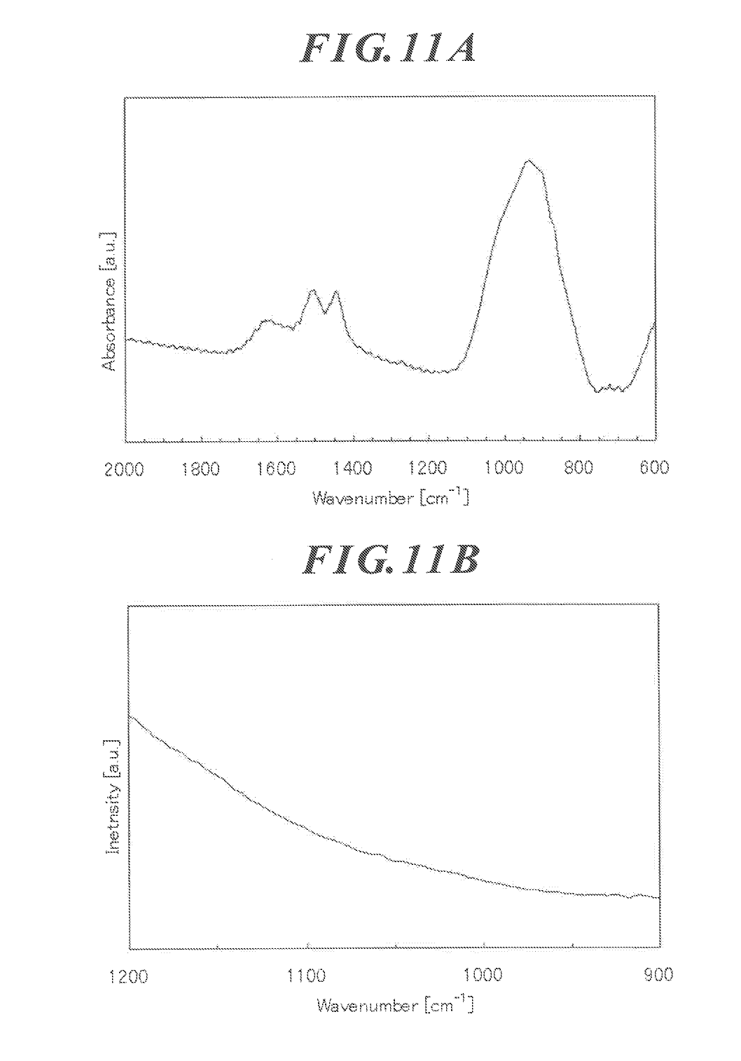

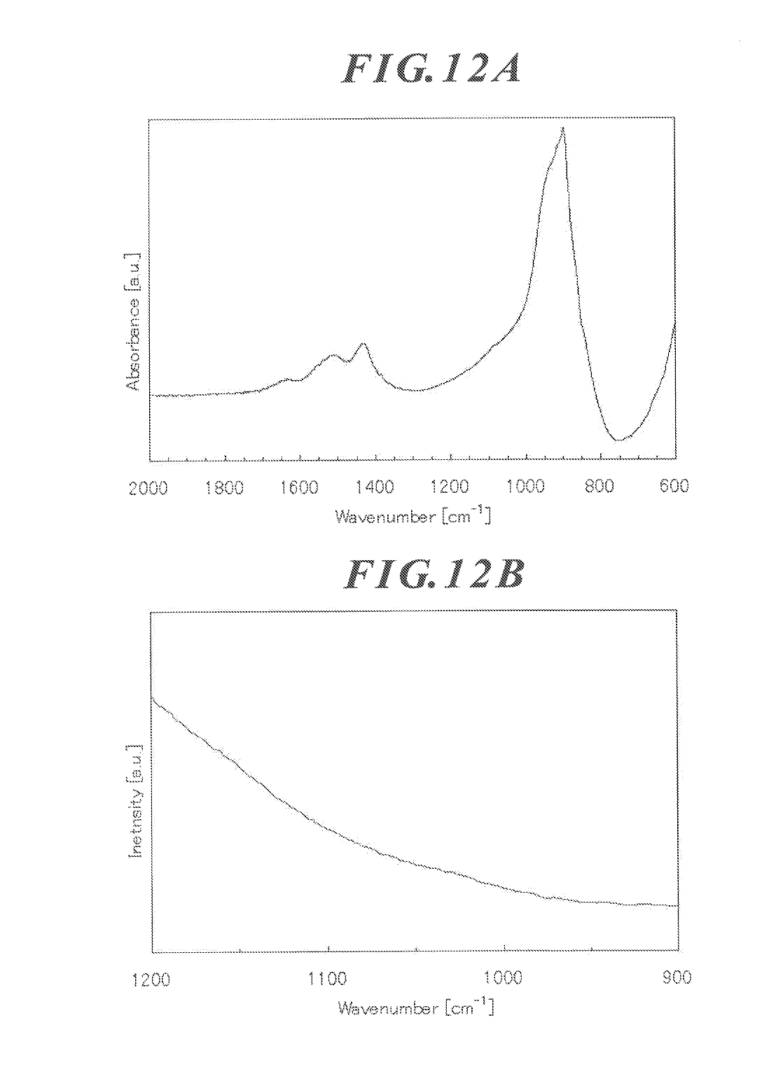

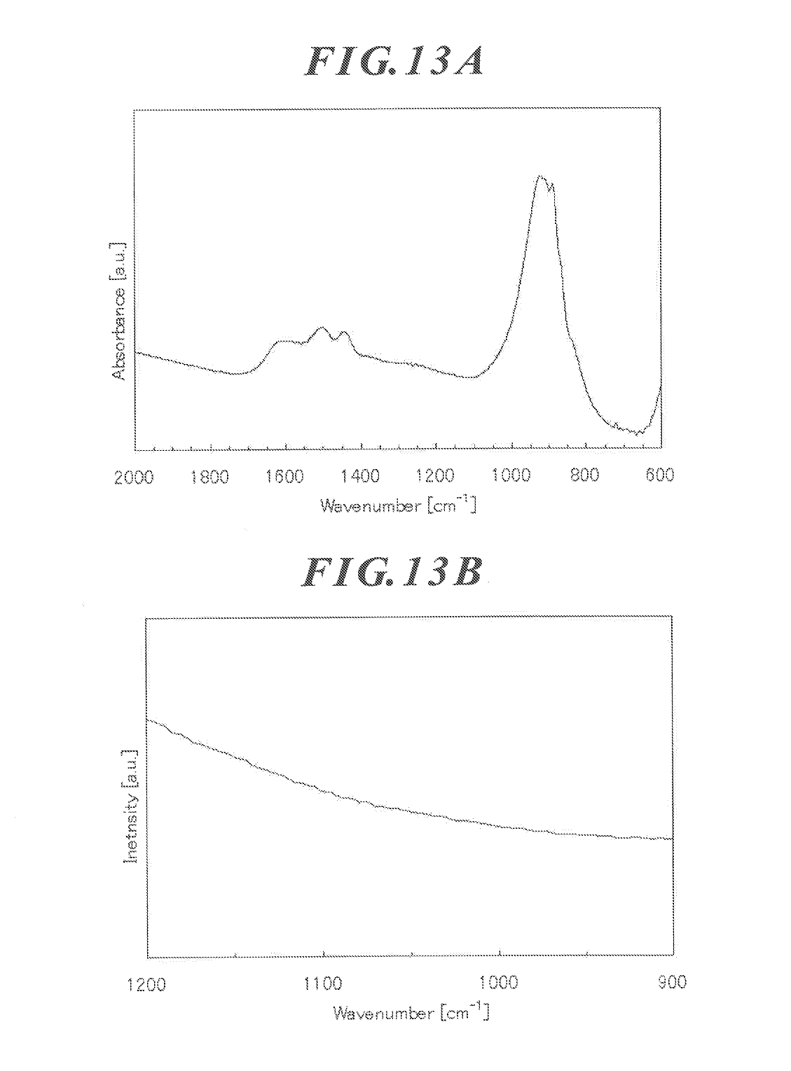

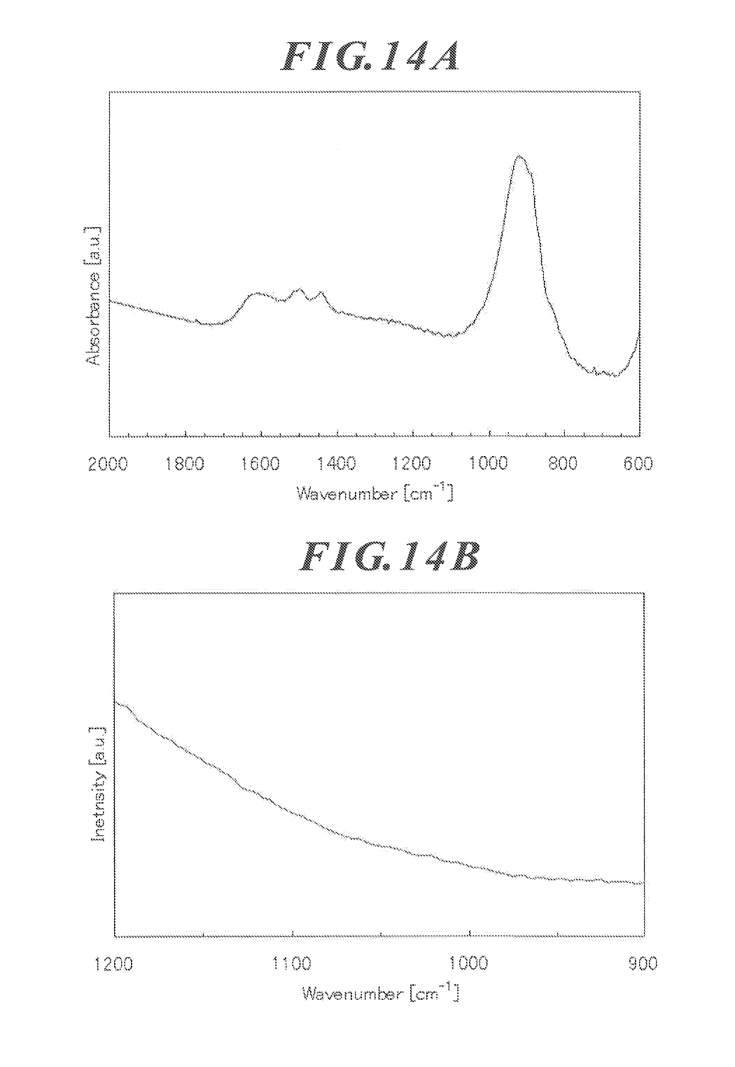

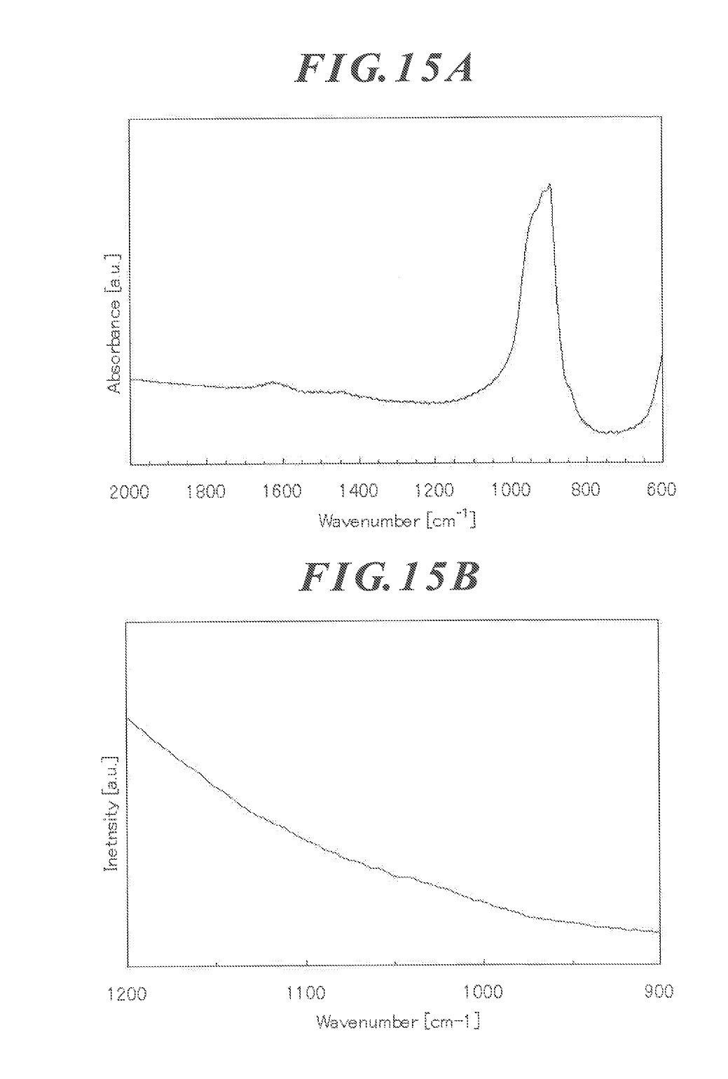

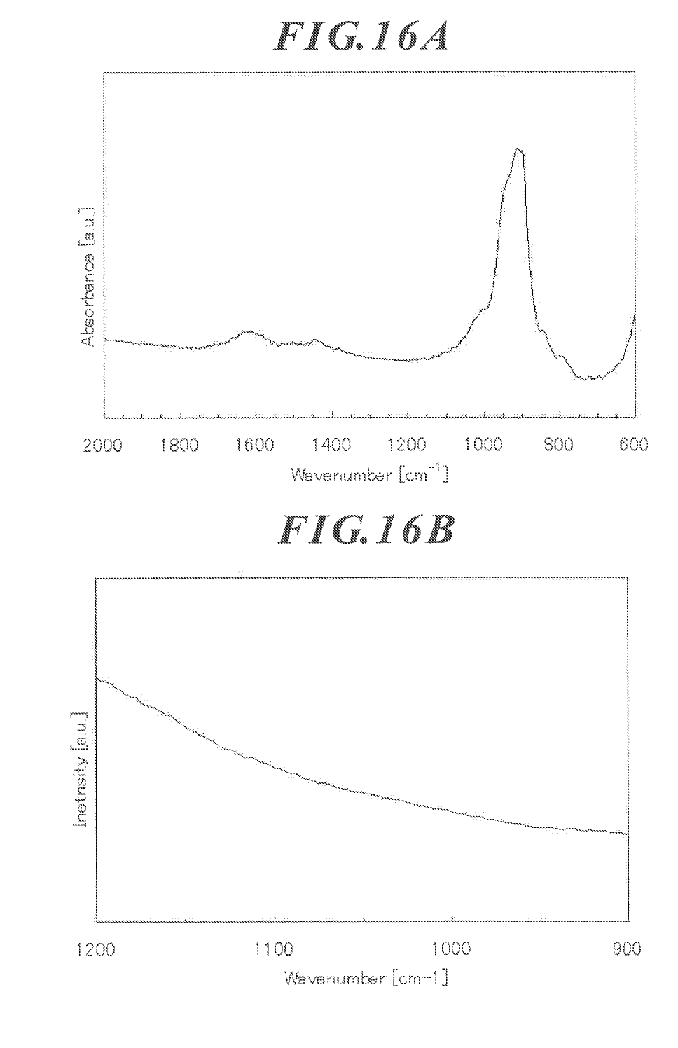

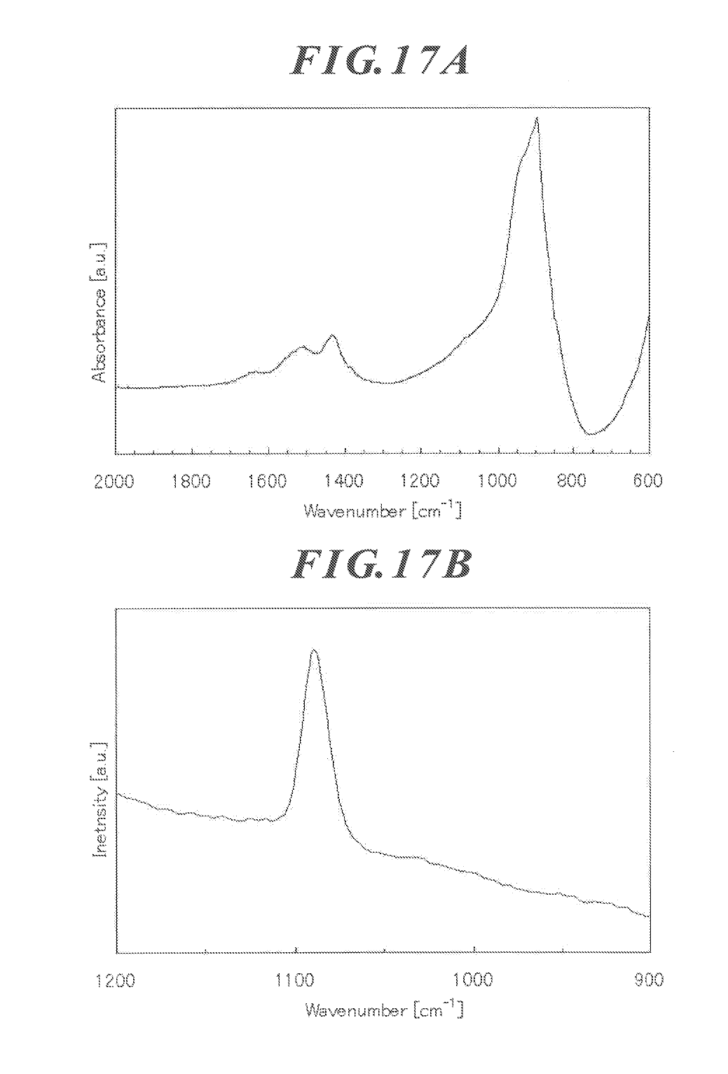

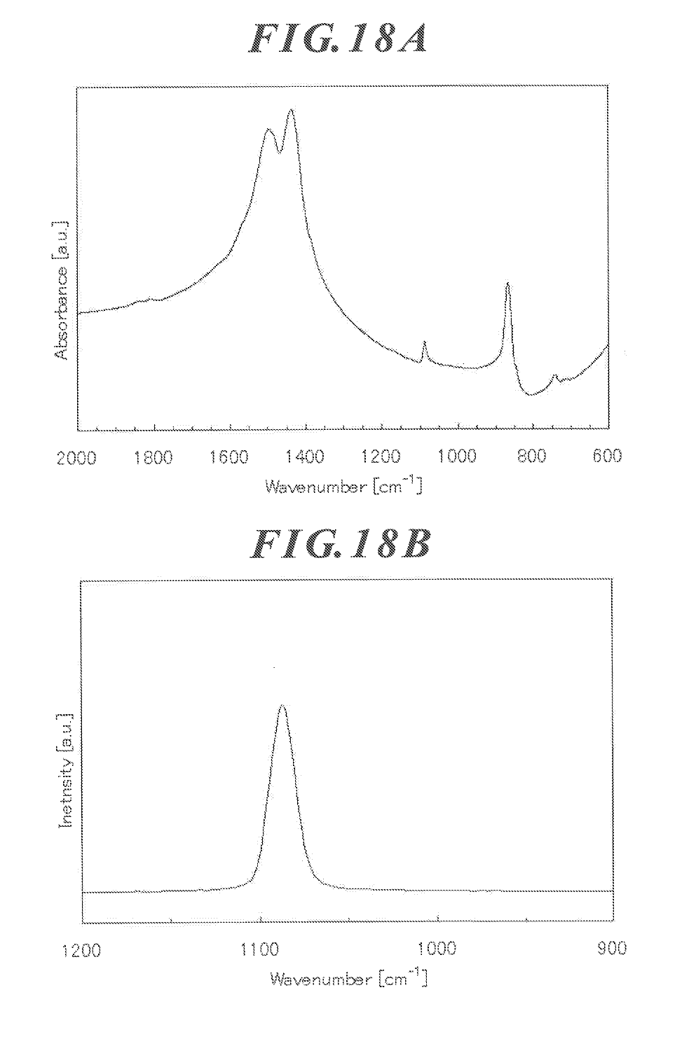

The samples of Example 1 to Example 10, Comparative Example 1, Comparative Example 2, Reference Example 1 and Reference Example 2 were subjected to infrared spectrometry to obtain infrared absorption spectra. The infrared absorption spectrometry was conducted using an infrared spectrophotometer (Fourier transform infrared spectrophotometer FT/IR-6200, from JASCO Corporation), based on transmission spectrometry using KBr pellet, with a number of times of integration of 100 times and a resolution of 4 cm⁻¹. Infrared absorption spectral charts are shown in FIG. 5A to FIG. 18A,

Presence (yes) or absence (no) of the peak(s) in the wave number range from 1400 cm⁻¹ to 1550 cm⁻¹ of the infrared absorption spectra According to the Examples, Comparatives Examples and Reference Examples are listed in Table 1. Table 1 also lists values of peak area ratio Aₚ₁/Aₚ₂ determined from the individual infrared absorption spectral charts as described above.

TABLE 1

| | | IR ABSORPTION | | RAMAN | | CARBON | |
|---|---|---|---|---|---|---|---|
| | | SPECTRUM | | SPECTRUM | XPS | ANALYSIS | |
| | | PEAK | | PEAK | SHOULDER | CARBON | |
| | SAMPLE | [YES/NO] | Aₚ₁/Aₚ₂ | [YES/NO] | PEAK | CONTENT | |
| EXAMPLE 1 | Li₂FeSiO₄ | YES | 0.11 | NO | YES | 14.9 | mass % |
| EXAMPLE 2 | Li₂FeSiO₄ | YES | 0.17 | NO | YES | 11.3 | mass % |
| EXAMPLE 3 | Li₂(Fe_{0.9}Mg_{0.1})SiO₄ | YES | 0.03 | NO | YES | 6.3 | mass % |
| EXAMPLE 4 | Li₂(Fe_{0.9}Zn_{0.1})SiO₄ | YES | 0.04 | NO | YES | 6.3 | mass % |
| EXAMPLE 5 | Li₂MnSiO₄ | YES | 0.11 | NO | YES | 11.2 | mass % |
| EXAMPLE 6 | Li₂(Mn_{0.9}Mg_{0.1})SiO₄ | YES | 0.08 | NO | YES | 12.6 | mass % |
| EXAMPLE 7 | Li₂(Mn_{0.9}Zn_{0.1})SiO₄ | YES | 0.09 | NO | YES | 18.2 | mass % |
| EXAMPLE 8 | Li₂(Mn_{0.9}Ni_{0.1})SiO₄ | YES | 0.07 | NO | YES | 13.9 | mass % |
| EXAMPLE 9 | Li₂(Mn_{0.9}Cu_{0.1})SiO₄ | YES | 0.06 | NO | YES | 12.4 | mass % |
| EXAMPLE 10 | Li₂(Mn_{0.5}Fe_{0.5})SiO₄ | YES | 0.07 | NO | YES | 4.9 | mass % |
| COMPARATIVE | Li₂FeSiO₄ | NO | 0.01 | NO | NO | 8.8 | mass % |
| EXAMPLE 1 | | | | | | | |
| COMPARATIVE | Li₂FeSiO₄ | NO | 0.01 | NO | NO | 12.1 | mass % |
| EXAMPLE 2 | | | | | | | |

| | | | | | | |
|---|---|---|---|---|---|---|
| REFERENCE | Li₂FeSiO₄ + Li₂CO₃ | YES | 0.05 | YES | — | — |
| EXAMPLE 1 | | | | | | |
| REFERENCE | Li₂CO₃ | YES | 1.32 | YES | — | — |
| EXAMPLE 2 | | | | | | |

### (Raman Spectrum)

The samples of Examples, Comparative Examples and Reference Examples were subjected to Raman spectrometry to obtain Raman spectra. The Raman spectrometry was conducted usinq a Raman spectrophotometer (laser Raman spectrophotometer NRS-5100, from JASCO Corporation), with an excitation wavelength of 532 nm, an exposure time of 15 to 50 seconds, a number of times of integration of 2 to 20 times, a magnification of objective lens of 5× to 100×, and the aperture of a beam attenuator ranged from “open” to OD1.3. Raman spectral charts are shown in. FIG. 5B to FIG. 18E. Presence (yes) or absence (no) of the peak in the wave number range from 1000 cm⁻¹ to 1150 cm⁻¹ of the Raman spectra are listed in Table 1.

### (XPS Spectrum)

The samples of Examples and Comparative Example were subjected to XPS to obtain XPS spectra. The XPS spectrometry was conducted using an X-ray photoelectron spectrometer (X-ray photoelectron spectrophotometer ESCA-3400, from Shimadzu Corporation). Table 1 lists presence (yes) or absence (no) of the shoulder peak in the C₁₅ peak determined as described above from the XPS spectral charts.

### (Measurement of Carbon Content)

The carbon content of the samples of Examples and Comparative Examples was measured. The carbon content was measured using a carbon/sulfur analyzer (carbon/sulfur analyzer EMIA-320V, from HORIBA, Ltd.). The carbon contents (% by mass) are listed in Table 1.

### (Evaluation of Discharge Characteristics)

A CR2032 type coin batteries were manufactured by forming the cathodes each formed respectively by using the composite material powders composed of the lithium silicate crystals and the carbon materials which were manufactured in Examples and Comparative Examples as the cathode material, by forming the anodes using metallic lithium and by using a non-aqueous electrolytic solution as the electrolytic solution.

Each cathode was manufactured by mixing each of the powders synthesized in Examples and Comparative Examples and a mixture of acetylene black powder and polytetrafluoroethylene powder (TAB-2, from Hohsen Corporation) in the ratio by mass of 2:1, kneading the mixture in a mortar, and then applying under pressure the kneaded powders to a stainless steel mesh as the current collector of the cathode.

The anode was manufactured by applying a metallic lithium foil under pressure to a stainless steel mesh as the current collector of the anode.

The electrolytic solution used herein was a non-aqueous electrolytic solution composed of a 1:2 by volume mixed solvent of ethyl carbonate and dimethyl carbonate, and 1.0 mol/L of LiPF_{G} dissolved therein.

The separator used herein was a porous polypropylene of 25 μm thick.

CR2032 type coin battery was assembled using the cathode, the anode, the electrolytic solution and the separator. The batteries were assembled in a glove box with a controlled argon atmosphere.

Each of the thus manufactured batteries was subjected to charge/discharge test in a thermostat chamber with a preset temperature of 25° C., to thereby measure the discharge capacity. The charge/discharge test was conducted in the voltage range from 1.5 V to 5.0 V. The charging was conducted with the upper limit voltage set to 5.0 V, according to the constant-current-constant-voltage (CCCV) scheme, at a charging rate of 0.1 C. The end point of constant voltage charging was determined when a capacity of 250 mAh/g was attained or when 600 minutes elapsed. The discharging was conducted with the lower limit voltage set to 1.5 V, according to the constant current (CC) scheme, at a discharging rate of 0.1 C.

Table 2 lists results of measurement of the discharge capacity of the individual batteries, and mass energy density values calculated from the discharge capacity.

TABLE 2

| | | CHARGE/DISCHARGE | |
|---|---|---|---|
| | | TEST | |
| | | | (MASS) |
| | | DISCHARGE | ENERGY |
| | SAMPLE | CAPACITY | DENSITY |
| EXAMPLE 1 | Li₂FeSiO₄ | 241 mAh/g | 628 Wh/Kg |
| EXAMPLE 2 | Li₂FeSiO₄ | 232 mAh/g | 580 Wh/Kg |
| EXAMPLE 3 | Li₂(Fe_{0.9}Mg_{0.1})SiO₄ | 188 mAh/g | 463 Wh/Kg |
| EXAMPLE 4 | Li₂(Fe_{0.9}Zn_{0.1})SiO₄ | 188 mAh/g | 469 Wh/Kg |
| EXAMPLE 5 | Li₂MnSiO₄ | 223 mAh/g | 663 Wh/Kg |
| EXAMPLE 6 | Li₂(Mn_{0.9}Mg_{0.1})SiO₄ | 223 mAh/g | 668 Wh/Kg |
| EXAMPLE 7 | Li₂(Mn_{0.9}Zn_{0.1})SiO₄ | 233 mAh/g | 699 Wh/Kg |
| EXAMPLE 8 | Li₂(Mn_{0.9}Ni_{0.1})SiO₄ | 222 mAh/g | 658 Wh/Kg |
| EXAMPLE 9 | Li₂(Mn_{0.9}Cu_{0.1})SiO₄ | 220 mAh/g | 645 Wh/Kg |
| EXAMPLE 10 | Li₂(Mn_{0.5}Fe_{0.5})SiO₄ | 231 mAh/g | 611 Wh/Kg |
| COMPARATIVE | Li₂FeSiO₄ | 158 mAh/g | 416 Wh/Kg |
| EXAMPLE 1 | | | |
| COMPARATIVE | Li₂FeSiO₄ | 141 mAh/g | 370 Wh/Kg |
| EXAMPLE 2 | | | |

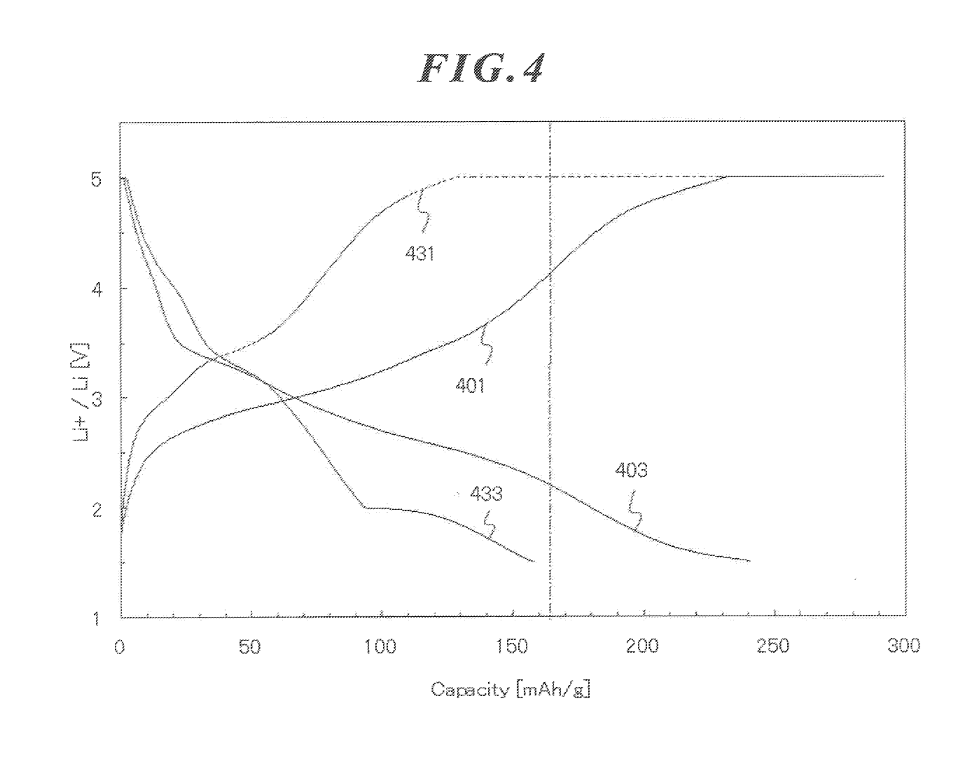

FIG. 4 illustrates charging/discharging curves (charging curve 401, discharging curve 403) obtained by the charge/discharge test of the battery using the powder of Example 1. FIG. 4 also illustrates charging/discharging curves (charging curve 431, discharging curve 433) obtained by the charge/discharge test of the battery using the powder of Comparative Example 1.

As shown in Table 1, values of the peak area ratio Aₚ₁/Aₚ₂ of Example 1 to Example 10 satisfy 0.02<Aₚ₁/Aₚ₂. As shown in Table 1 and Table 2, large values of capacity of 165 mAh/g or above were obtained in Example 1 to Example 10 which showed values of the peak area ratio 0.02<Aₚ₁/Aₚ₂. Again by Example 1 to Example 10, also large values of mass energy density of 463 Wh/kg to 699 Wh/kg were obtained. In contrast, Comparative Examples 1 and 2 showed only small values of the peak area ratio Aₚ₁/Aₚ₂ of 0.01 or around, with small values of discharge capacity and mass energy density.

Again as shown in Table 1, among Examples which showed the peaks in the wave number range from 1400 cm⁻¹ to 1550 cm⁻¹ of the infrared absorption spectrum, only Reference Example 1 and Reference Example 2 were found to show the peak in the wave number range from 1000 cm⁻¹ to 1150 cm⁻¹ of the Raman spectrum.

### INDUSTRIAL APPLICABILITY

The present invention is usable in the field of lithium ion secondary battery.

### EXPLANATION OF SYMBOLS

101 infrared absorption spectrum of the invention
201 Raman spectrum of the invention
211. Raman spectrum of lithium carbonate
301 C₁ₛ peak in XPS spectrum of the invention
313 shoulder peak of the invention
401 charging curve of Example 1
403 discharging curve of Example 1
431 charging curve of Comparative Example 1
433 discharging curve of Comparative Example 1

What is claimed is:

1. A cathode material for lithium ion secondary battery, wherein;
the cathode material comprises a composite material of a lithium silicate crystal and a carbon material, and wherein;
the composite material shows a peak in a wave number range from 1400 cm⁻¹ to 1550 cm⁻¹ in infrared absorption spectrum, and shows no peak in a wave number range from 1000 cm⁻¹ to 1150 cm⁻¹ in Raman spectrum.

2. The cathode material for lithium ion secondary battery of claim 1,
wherein 0.02<Aₚ₁/Aₚ₂ holds in an infrared absorption spectral chart of the infrared absorption spectrum,
where, Aₚ₁ represents an area of a region surrounded by an infrared absorption spectral curve and a first straight line which connects a point corresponding to an absorbance at a wave number of 1400 cm⁻¹ and a point corresponding to an absorbance at a wave number of 1550 cm⁻¹, and
Aₚ₂ represents an area of a region surrounded by the infrared absorption spectral curve and a second straight line which connects a point corresponded to an absorbance at a wave number of 800 cm⁻¹ and a point corresponded to an absorbance at a wave number of 1110 cm⁻¹.

3. The cathode material for lithium ion secondary battery of claim 1,
wherein the composite material shows a C_{1S} peak, in XPS spectrum of the composite material, that contains a shoulder peak located on a higher energy side of an SP² peak and an SP³ peak.

4. The cathode material for lithium ion secondary battery of claim 1,
wherein the composite material has a sea-island structure in which the lithium silicate crystal is scattered like islands in the carbon material.

5. The cathode material for lithium ion secondary battery of claim 1,
wherein the composite material is obtained by pyrolyzing and reacting a solution which contains at least a compound which contains an element composing the lithium silicate crystal and an organic compound which produces the carbon material, while keeping the solution in a form of liquid droplets so as to obtain intermediate, and then by heat-treating the intermediate in an inert atmosphere or in a reductive atmosphere at 400° C. or higher, and lower than a melting point of the lithium silicate crystal.

6. A cathode for lithium ion secondary battery, comprising;
a current collector, and
a cathode layer comprising the cathode material of claim 1 and a binder, the cathode layer being provided over the current collector.

7. A lithium ion secondary battery, comprising:
the cathode of claim 6, an anode, a separator, and a non-aqueous electrolytic solution.
